(19) United States
(12) Patent Application Publication
(10) Pub. No.: US 2026/0153662 A1
(43) Pub. Date: Jun. 4, 2026

(54) POLARIZING ELEMENT

(71) Applicant: HOYA CORPORATION, Tokyo (JP)

(72) Inventor: Yoshitaka YONEDA, Tokyo (JP)

(73) Assignee: HOYA CORPORATION, Tokyo (JP)

(21) Appl. No.: 19/126,787

(22) PCT Filed: Nov. 10, 2023
(86) PCT No.: PCT/JP2023/040512

§ 371 Date: Dec. 17, 2025

(30) Foreign Application Priority Data
Nov. 11, 2022 (JP) 2022-180655

(51) Int. Cl. C03C 3/087; C03C 3/091; C03C 3/093

(52) U.S. Cl. CPC G02B 5/3058; G02B 1/115

(57) ABSTRACT

An object is to provide a polarizing element capable of reducing insertion loss and increasing extinction ratio by adjusting the particle diameter of metal microparticles.

The polarizing element (1) of the present disclosure comprises a glass substrate (2), a plurality of cavities (3) formed inside the glass substrate extending in one direction, and metal microparticles (4) arranged within each cavity having a volume smaller than the cavities, and is wherein: an average diameter of the metal microparticles, along a transversal direction orthogonal to a longitudinal direction of the cavities, is 20 nm or less, and a particle diameter of the metal microparticles, at a cumulative frequency of 90%, is 30 nm or less.

### TECHNICAL FIELD

The present invention relates to a polarizing element capable of achieving low insertion loss.

### BACKGROUND ART

Generally, optical characteristics required for a polarizing element are evaluated by insertion loss and extinction ratio. Namely, a favorable polarizing element is a polarizing element that has a high extinction ratio and a small insertion loss.

For example, when polarizing glass is utilized in an optical isolator, if the insertion loss is high, higher output becomes necessary when sending an optical signal to a transmission system. For this reason, the burden placed on the semiconductor laser as a light source increases.

The invention described in Patent Literature 1 discloses a polarizing element having metal microparticles generated within numerous regions that the metal halide microparticles occupied before reduction, by heat-treating glass, in which numerous substantially needle-shaped metal halide microparticles are oriented and dispersed in substantially one direction, in a reducing atmosphere to reduce the metal halide microparticles, the polarizing element defining the individual volume of the numerous regions, and the packing factor of the metal microparticles occupying the regions.

Thus, according to Patent Literature 1, it is stated that by adjusting the size of each region generated within the glass substrate, and the packing factor of the metal microparticles occupying within the regions, improvement of optical characteristics can be achieved.

Furthermore, Patent Literature 2 discloses an optical isolator with improved weather resistance and excellent long-term reliability. This patent document provides a borosilicate-based glass consisting of predetermined materials as polarizing glass that does not break even when stretched by applying a certain degree of high tension during the stretching or drawing of a glass preform.

### CITATION LIST

### Patent Literatures

Patent Literature 1: Japanese Patent No. 4642921
Patent Literature 2: International Publication No. WO 2007/119794

### SUMMARY OF INVENTION

### Technical Problem

The present inventor conducted diligent research regarding the relationship between constituent elements and optical characteristics, a relationship not focused on in Patent Literature 1 and Patent Literature 2.

The present invention was made in view of such circumstances, and an object thereof is to provide a polarizing element capable of reducing insertion loss and increasing extinction ratio by adjusting the particle diameter of metal microparticles.

### Solution to Problem

The polarizing element according to the present invention comprises: a glass substrate; a plurality of cavities formed inside the glass substrate extending in one direction; and metal microparticles arranged within each cavity having a volume smaller than the cavities, and is wherein: an average diameter of the metal microparticles, along a transversal direction orthogonal to a longitudinal direction of the cavities, is 20 nm or less, and a particle diameter of the metal microparticles, at a cumulative frequency of 90%, is 30 nm or less.

One aspect of the polarizing element according to the present invention is wherein an aspect ratio of the metal microparticles, at a cumulative frequency of 90%, is 6 or more and 16 or less.

One aspect of the polarizing element according to the present invention is wherein the average diameter of the metal microparticles is 18 nm or less, and the particle diameter of the metal microparticles, at a cumulative frequency of 90%, is 26 nm or less.

One aspect of the polarizing element according to the present invention is wherein an average value of a volume of the cavities is 150,000 nm³ or more and 650,000 nm³ or less.

One aspect of the polarizing element according to the present invention is wherein a total volume sum of the metal microparticles, with respect to a volume of the cavities, is, as an average value, 12% or more and 25% or less.

One aspect of the polarizing element according to the present invention is wherein it has an anti-reflection film on one surface of the polarizing element, and for light in a wavelength band of 1270 nm to 1650 nm, an insertion loss is 0.204 dB or less.

One aspect of the polarizing element according to the present invention is wherein an extinction ratio, at a measurement distance of 5 mm, is 38 dB or more.

One aspect of the polarizing element according to the present invention is wherein, for light of wavelength 1270 nm, an extinction ratio, at a measurement distance of 5 mm, is 38 dB or more, and for light of wavelength 1650 nm, an extinction ratio, at a measurement distance of 300 mm, is 50 dB or more.

One aspect of the polarizing element according to the present invention is wherein the metal microparticles are Cu microparticles or Ag microparticles.

### Advantageous Effects of Invention

According to the polarizing element of the present invention, insertion loss can be reduced, and the extinction ratio can be increased, making it possible to obtain excellent optical characteristics.

### BRIEF DESCRIPTION OF DRAWINGS

FIG. 1 is a schematic cross-sectional view of the polarizing glass according to the present embodiment.

FIG. 2 is a schematic cross-sectional view of a cavity.

FIG. 3 is a schematic cross-sectional view of metal microparticles arranged inside a cavity.

FIG. 4 is a transmission electron microscope photograph of Cu-containing polarizing glass with a heat treatment temperature of 667° C.

FIG. 5 is a transmission electron microscope photograph of Cu-containing polarizing glass with a heat treatment temperature of 670° C.

FIG. 6 is a transmission electron microscope photograph of Cu-containing polarizing glass with a heat treatment temperature of 681° C.

FIG. 7 is a cumulative frequency distribution diagram of the volume of metal halide microparticles (CuCl).

FIG. 8 is a cumulative frequency distribution diagram of the particle diameter of metal halide microparticles (CuCl).

FIG. 9 is a cumulative frequency distribution diagram of the aspect ratio of metal halide microparticles (CuCl).

FIG. 10 is a cumulative frequency distribution diagram of the particle diameter of metal microparticles (Cu).

FIG. 11 is a graph showing the relationship between the heat treatment temperature and the average diameter of metal microparticles (Cu).

FIG. 12 is a graph showing the relationship between the heat treatment temperature and the particle diameter at a cumulative frequency of 90% of metal microparticles (Cu).

FIG. 13 is a cumulative frequency distribution diagram of the number of metal microparticles (Cu).

FIG. 14 is a cumulative frequency distribution diagram of the aspect ratio of metal microparticles (Cu).

FIG. 15 is a cumulative frequency distribution diagram of the volume of metal microparticles (Cu).

FIG. 16 is a cumulative frequency distribution diagram of the volume ratio (packing factor) of metal microparticles (Cu) relative to the cavities.

FIG. 17 is a graph showing the relationship between the average diameter of metal microparticles (Cu) and insertion loss.

FIG. 18 is a graph showing the relationship between the average diameter of metal microparticles (Cu) and extinction ratio.

FIG. 19 is a transmission electron microscope photograph of Ag-containing polarizing glass with a heat treatment temperature of 692° C.

FIG. 20 is a transmission electron microscope photograph of Ag-containing polarizing glass with a heat treatment temperature of 700° C.

FIG. 21 is a cumulative frequency distribution diagram of the volume of metal halide microparticles (AgClBr).

FIG. 22 is a cumulative frequency distribution diagram of the particle diameter of metal halide microparticles (AgClBr).

FIG. 23 is a cumulative frequency distribution diagram of the aspect ratio of metal halide microparticles (AgClBr).

FIG. 24 is a cumulative frequency distribution diagram of the particle diameter of metal microparticles (Ag).

FIG. 25 is a graph showing the relationship between the heat treatment temperature and the average diameter of metal microparticles (Ag).

FIG. 26 is a graph showing the relationship between the heat treatment temperature and the particle diameter at a cumulative frequency of 90% of metal microparticles (Ag).

FIG. 27 is a cumulative frequency distribution diagram of the number of metal microparticles (Ag).

FIG. 28 is a cumulative frequency distribution diagram of the aspect ratio of metal microparticles (Ag).

FIG. 29 is a cumulative frequency distribution diagram of the volume of metal microparticles (Ag).

FIG. 30 is a cumulative frequency distribution diagram of the volume ratio (packing factor) of metal microparticles (Ag) relative to the cavities.

FIG. 31 is a graph showing the relationship between the average diameter of metal microparticles (Ag) and insertion loss.

FIG. 32 is a graph showing the relationship between the average diameter of metal microparticles (Ag) and extinction ratio.

### DESCRIPTION OF EMBODIMENTS

Hereinafter, one embodiment of the present invention (hereinafter, abbreviated as “embodiment”) will be described in detail. It should be noted that the present invention is not limited to the following embodiment, and can be implemented by being variously modified within the scope of its gist. Also, regarding the notation “to,” it includes both the lower limit value and the upper limit value as the range.

### <Circumstances Leading to the Polarizing Element of the Present Embodiment>

The polarizing element in the present embodiment (also referred to as polarizing glass) has a function of transmitting polarized light in a specific vibration direction (referred to as a “polarization transmission axis”), while absorbing polarized light in a direction orthogonal thereto (referred to as a “polarization extinction axis”).

Optical characteristics required for a polarizing element are a high extinction ratio and a low insertion loss. “Extinction ratio” is the ratio of the transmittance of light in a direction parallel to the polarization extinction axis to the transmittance of light in a direction parallel to the polarization transmission axis: the higher the extinction ratio, the more excellent are the optical characteristics. The unit is dB. Furthermore, “Insertion loss” refers to the loss experienced by light parallel to the polarization transmission axis when passing through the polarizing element: the lower the insertion loss, the more excellent are the optical characteristics. The unit is dB.

As a result of diligent research, the present inventor focused on the particle diameter of metal microparticles contained within the glass substrate, derived the relationship between the particle diameter of metal microparticles and insertion loss, and the relationship between the particle diameter of metal microparticles and extinction ratio, and came to develop a polarizing element capable of obtaining favorable optical characteristics.

Namely, the polarizing element of the present embodiment is characterized by (1) comprising a glass substrate, a plurality of cavities formed inside the glass substrate extending in one direction, and metal microparticles arranged within each cavity having a volume smaller than the cavities, and (2) an average diameter of the metal microparticles, along a transversal direction orthogonal to a longitudinal direction of the cavities, being 20 nm or less, and the particle diameter of the metal microparticles, at a cumulative frequency of 90%, being 30 nm or less.

In contrast, Patent Literature 1 does not describe the average diameter of metal microparticles and the particle diameter of metal particles at a cumulative frequency of 90%. Furthermore, Patent Literature 2 discloses copper particles with an average diameter of about 30 nm in an example, but has not been able to achieve metal microparticles with an average diameter of 20 nm or less. Furthermore, Patent Literature 2 does not describe the particle diameter of metal particles at a cumulative frequency of 90%.

### <Outline of the Polarizing Element of the Present Embodiment>

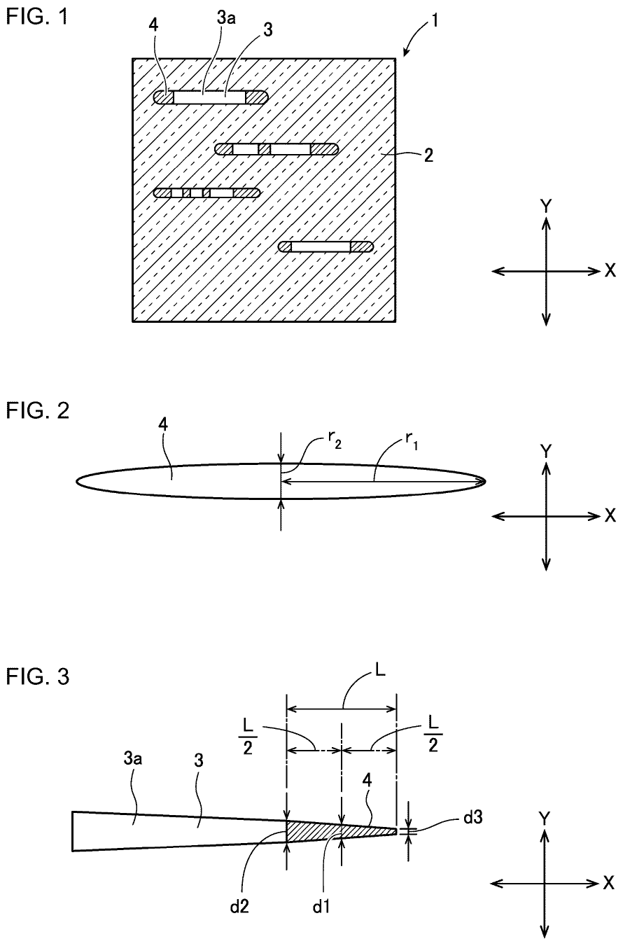

FIG. 1 is a schematic cross-sectional view of polarizing glass 1 according to the present embodiment. As shown in FIG. 1, the polarizing glass 1 is configured comprising a glass substrate 2, a plurality of cavities 3 formed inside the glass substrate 2 extending in one direction, and metal microparticles 4 arranged within each cavity 3 having a volume smaller than the cavity 3.

### [Glass Substrate 2]

Although the glass composition is not limited, borosilicate glass is preferably applied. For example, the glass composition can be appropriately adjusted according to the type of metal halide microparticles to be precipitated.

As one example, the composition of the glass substrate 2 is: SiO₂ at about 50 to 65% by weight (WT %), B₂O₃ at about 15 to 25% by weight, Al₂O₃ at about 4 to 8% by weight, AlF₃ at about 1 to 3% by weight, Y₂O₃ at about 1 to 3% by weight, Na₂O at about 5 to 10% by weight, and SnO at about 0.01 to 0.5% by weight.

### [Cavity 3]

As shown in FIG. 1, numerous cavities 3 are formed inside the glass substrate 2. Each cavity 3 has its longitudinal direction oriented all in the same direction (X direction). The cavity 3 is a trace where a metal halide microparticle existed.

FIG. 2 is an enlarged schematic cross-sectional view of the cavity 3. Assuming each cavity 3 is a spheroid as shown in FIG. 2, the volume of the cavity 3 can be determined by the following formula (1).

$$Volume of Cavity 3 = 4 π \cdot {r}_{1} ( {( {r}_{2} / 2 )}^{2} ) / 3 \qquad [ Math . 1 ]$$

Here, r₁ is half the length along the center line in the longitudinal direction (X direction) of the cavity 3, and r₂ indicates the length in the transversal direction (Y direction) orthogonal at the central position in the longitudinal direction of the cavity 3.

The average value of the volume of the cavity 3 is preferably 150,000 nm³ or more and 650,000 nm³ or less. The average value of the volume of the cavity 3 is obtained by measuring the volumes of a plurality of cavities 3 appearing within a predetermined region of a TEM photograph and dividing the sum of each volume by the number of samples. At this time, the number of samples for volume is preferably about 10 to 50. Furthermore, the volume of the cavity 3 is preferably 450,000 nm³ or more and 950,000 nm³ or less at a cumulative frequency of 90%. The value at a cumulative frequency of 90% can be evaluated by arranging the volumes of a plurality of cavities 3 appearing within a predetermined region of a TEM photograph in ascending order, and taking the value at the point where 90% of the total number is reached. The value at cumulative frequency 90% is a value close to the maximum value of the samples that contributed to the measurement. By defining the value at cumulative frequency 90% together with the average value, the distribution can be defined finely, and highly accurate optical characteristics can be obtained.

The average value of the volume of the cavity 3 is more preferably 200,000 nm³ or more and 650,000 nm³ or less, still more preferably 200,00 nm³ or more and 550,000 nm³ or less, and even still more preferably 200,00 nm³ or more and 450,000 nm³ or less.

Note that the volume of the cavity 3 can be regarded as the volume of the metal halide microparticles. The volume of the cavity 3 depends on the heat treatment temperature and heat treatment time when precipitating the metal halide microparticles in the glass substrate 2; when the heat treatment time is constant, if the heat treatment temperature becomes higher, the metal halide microparticles precipitate more easily, the particle diameter of the spherical metal halide microparticles becomes larger, and as a result, the cavity 3 as the trace where the metal halide microparticles existed also becomes larger.

### [Metal Microparticle 4]

The metal microparticle 4 is a microparticle composed of a metal element obtained by reducing metal halide microparticles. Although depending on the performance of the analysis equipment, if halogen is not detected from the metal microparticle 4, or at least, if it can be estimated that the metal microparticle 4 was obtained by reducing metal halide microparticles, it corresponds to the “metal microparticle 4” of the present embodiment.

As shown in FIG. 1, the metal microparticle 4 exists with a volume smaller than the cavity 3. Therefore, in each cavity 3, there exists a non-embedded portion 3a that is not filled by the metal microparticles 4. In Transmission Electron Microscope (TEM) photographs described later, scattering is stronger for heavier elements, reducing the amount of transmitted electrons, thus the metal microparticles 4 are normally photographed as black.

As shown in FIG. 1, one or a plurality of metal microparticles 4 are included within each cavity 3, and the number is not limited. Each cavity 3 contains about 1 to 10 metal microparticles 4, preferably about 2 to 6, more preferably about 2 to 4.

As shown in FIG. 1, the metal microparticles 4 tend to be arranged at one end or both ends in the longitudinal direction (X direction) of the cavity 3. When observed with a transmission electron microscope photograph, many metal microparticles 4 arranged at both ends in the longitudinal direction (X direction) of the cavity 3 are seen. Furthermore, configurations are also seen where one or a plurality of metal microparticles 4 are scattered spaced apart inward from both ends in the longitudinal direction (X direction) of the cavity 3.

In the present embodiment, the average value of the particle diameter in the Y direction of the metal microparticle 4 shown in FIG. 1 (hereinafter referred to as the average diameter of the metal microparticle 4) is characterized by being 20 nm or less. Namely, the average diameter of the metal microparticle 4 is defined by the length along the transversal direction (Y direction) orthogonal to the longitudinal direction (X direction) of the cavity 3. The average diameter of the metal microparticle 4 is obtained by measuring the particle diameters of a plurality of metal microparticles 4 appearing within a predetermined region of a TEM photograph and dividing the sum of each particle diameter by the number of samples. At this time, the number of samples for particle diameter may be 10 or more, preferably 30 or more, more preferably 50 or more. The accuracy of the average value can be increased as the number of samples increases, but an upper limit value of about 100 is sufficient. The same applies to the measurement at a cumulative frequency of 90%.

In the present embodiment, in addition to the above average diameter, the particle diameter in the Y direction of the metal microparticle 4 is characterized by being 30 nm or less at a cumulative frequency of 90%. Cumulative frequency 90% refers to the particle diameter that corresponds to 90% of the total number of metal microparticles when counting in order from the smallest particle diameter.

FIG. 3 is a partial schematic diagram showing approximately the right half of the cavity 3 from the central position in the longitudinal direction (X direction), where the metal microparticle 4 is arranged at the right end of the cavity 3. It is assumed that the metal microparticle 4 has a truncated cone shape, or a shape combining two truncated cones. As shown in FIG. 3, the particle diameter of the metal microparticle 4 is defined by the length d1 in the transversal direction (Y direction) at the position halfway along the longitudinal direction (X direction) L. Alternatively, the particle diameter of the metal microparticle 4 is defined by the length d1 in the transversal direction (Y direction) passing through the center position (center of gravity) of the shape of the metal microparticle. Note that, as shown in FIG. 3, not limited to the metal microparticle 4 arranged at the end position of the cavity 3, but also for metal microparticles 4 spaced inward from both ends of the cavity 3, and regardless of the shape of the metal microparticle 4, for any metal microparticle 4, the particle diameter is defined by the length d1 in the transversal direction (Y direction) at the position halfway along the longitudinal direction (X direction) L, or the length d1 in the transversal direction (Y direction) passing through the center position (center of gravity).

Although the lower limit value of the average diameter of the metal microparticle 4 is not limited, it is preferably 10 nm or more. To make the particle diameter of the metal microparticle 4 smaller, for example, by increasing the tension when stretching the metal halide microparticles, the metal halide microparticles can be stretched more elongatedly, and consequently, the particle diameter of the metal microparticle 4 can be made smaller, but if the tension is too high, the glass substrate 2 may suffer breakage or the like. For this reason, the lower limit value of the average diameter of the metal microparticle 4 was set to 10 nm so that the glass substrate 2 can maintain a normal state.

It has been proven by experiments described later that by adjusting the average diameter of the metal microparticle 4 to 20 nm or less, insertion loss can be effectively reduced. Namely, in the present embodiment, it was found that the particle diameter of the metal microparticle 4 is a factor that influences the magnitude of insertion loss. It is presumed that the insertion loss becomes smaller because reducing the particle diameter of the metal microparticle 4 decreases the scattered light intensity due to the metal microparticle 4.

In the present embodiment, the average diameter of the metal microparticle 4 is preferably set to 19 nm or less, more preferably set to 18 nm or less, still more preferably set to 17.5 nm or less, and most preferably set to 17.0 nm or less.

In the present embodiment, in addition to the average diameter of the metal microparticle 4, the particle diameter of the metal microparticle 4 is 30 nm or less at a cumulative frequency of 90%. In this way, by defining both the average diameter of the metal microparticle 4 and the particle diameter at a cumulative frequency of 90%, the distribution can be defined finely, and highly accurate optical characteristics (insertion loss and extinction ratio) can be obtained. In the present embodiment, the particle diameter of the metal microparticle 4, at a cumulative frequency of 90%, is preferably 15 nm or more and 30 nm or less, more preferably 26 nm or less, and still more preferably 17 nm or more and 26 nm or less.

The material of the metal microparticle 4 is not limited, but preferably, copper (Cu) particles or silver (Ag) particles are selected. When the metal microparticle 4 is a copper particle, as the Cu halide microparticle, for example, CuCl (cuprous halide) can be selected. When the metal microparticle 4 is a silver particle, as the Ag halide microparticle, for example, AgCl (silver (I) halide) can be selected. The metal microparticle 4 may be an alloy, or multiple types of metal microparticles 4 made of different materials may be included.

The average value of the volume of each metal microparticle 4 in the present embodiment is preferably 10,000 nm³ or more and 25,000 nm³ or less, more preferably 12,000 nm³ or more and 20,000 nm³ or less, and still more preferably 14,000 nm³ or more and 19,000 nm³ or less. Furthermore, the volume of each metal microparticle 4, at a cumulative frequency of 90%, is preferably 20,000 nm³ or more and 45,000 nm³ or less, more preferably 25,000 nm³ or more and 40,000 nm³ or less, and most preferably 28,000 nm³ or more and 35,000 nm³ or less. The volume of the metal microparticle 4 referred to here indicates the volume per single metal microparticle 4.

Furthermore, the average value of the volume of each metal halide microparticle in the present embodiment is preferably 150,000 nm³ or more and 650,000 nm³ or less, more preferably 150,000 nm³ or more and 550,000 nm³ or less. It is still more preferably 150,000 nm³ or more and 500,000 nm³ or less, and most preferably 150,000 nm³ or more and 450,000 nm³ or less. Furthermore, the volume of each metal halide microparticle 4, at a cumulative frequency of 90%, is preferably 450,000 nm³ or more and 950,000 nm³ or less, more preferably 450,000 nm³ or more and 900,000 nm³ or less, still more preferably 450,000 nm³ or more and 850,000 nm³ or less, and most preferably 450,000 nm³ or more and 800,000 nm³ or less.

Assuming the metal microparticle 4 has a truncated cone shape or a shape combining two truncated cones, the volume of the metal microparticle 4 can be determined by the following formula (2).

$$[ Math . 2 ]$$

$$\begin{matrix}Volume of Metal Microparticles = ( {( d 2 / 2 )}^{2} + d 2 \times d 1 / 4 + {( d 1 / 2 )}^{2} ) π L / 6 + \\ ( {( d 1 / 2 )}^{2} + d 1 \times d 3 / 4 + {( d 3 / 2 )}^{2} ) π L / 6\end{matrix} \qquad ( 2 )$$

Here, d1, d2, d3 indicate the diameters at each position shown in FIG. 3, and L indicates the length in the longitudinal direction (X direction) of the cavity 3.

Here, as shown in FIG. 3, the reason for calculating the volume of the metal microparticle 4 by dividing it into halves with respect to the length L is that, considering the metal microparticle 4 has a shape combining two truncated cones, it was assumed that the shape switches at approximately the halfway point.

In the present embodiment, as described above, since the average diameter of the metal microparticle 4 is 20 nm or less, and the particle diameter of the metal microparticle 4 at a cumulative frequency of 90% is 30 nm or less, which are small, the volume of the metal microparticle 4 can also be made small. By being able to make the volume of the metal microparticle 4 small, the scattered light intensity can be reduced. In the present embodiment, it is preferable that a plurality of metal microparticles 4 with such small volumes are arranged spaced apart within the cavity 3.

The metal aspect ratio is represented by the length L in the X direction of the metal microparticle 4 shown in FIG. 3/the length d1 in the Y direction of the metal microparticle 4. Therefore, a metal microparticle 4 with an aspect ratio greater than 1 is formed long towards the longitudinal direction (X direction) of the cavity 3, and a metal microparticle 4 with an aspect ratio smaller than 1 is formed long towards the transversal direction (Y direction) of the cavity 3.

Generally, when the metal aspect ratio is large, the resonance absorption for long-wavelength light in the polarization direction to be extinguished becomes large, and when the metal aspect ratio is small, the resonance absorption for short-wavelength light becomes large; therefore, in polarizing glass products, forming an appropriate magnitude of metal aspect ratio is important for achieving the extinction ratio in the required wavelength band.

In the polarizing glass of the present embodiment, a plurality of metal microparticles are generated within one metal halide particle through the stretching process and reduction process described later, and it has a structure where the volume of individual metal microparticles becomes small. Re-emitted light, where light resonantly absorbed by the metal microparticles forms an electric field and is re-emitted in random directions, is proportional to the square of the metal volume; therefore, by reducing the individual volume of the metal microparticles, re-emitted light from the polarizing glass is reduced, improving the extinction ratio at close measurement distances.

On the other hand, when the number of metal microparticles generated from one metal halide particle increases, a phenomenon occurs where the metal aspect ratio of the individual metal microparticles becomes smaller. At this time, if the metal aspect ratio becomes too small, the extinction ratio at long wavelengths becomes low as described above; therefore, even in a structure where numerous metal microparticles exist within the metal halide particle, it is necessary for metal microparticles having an aspect ratio of a certain magnitude to exist.

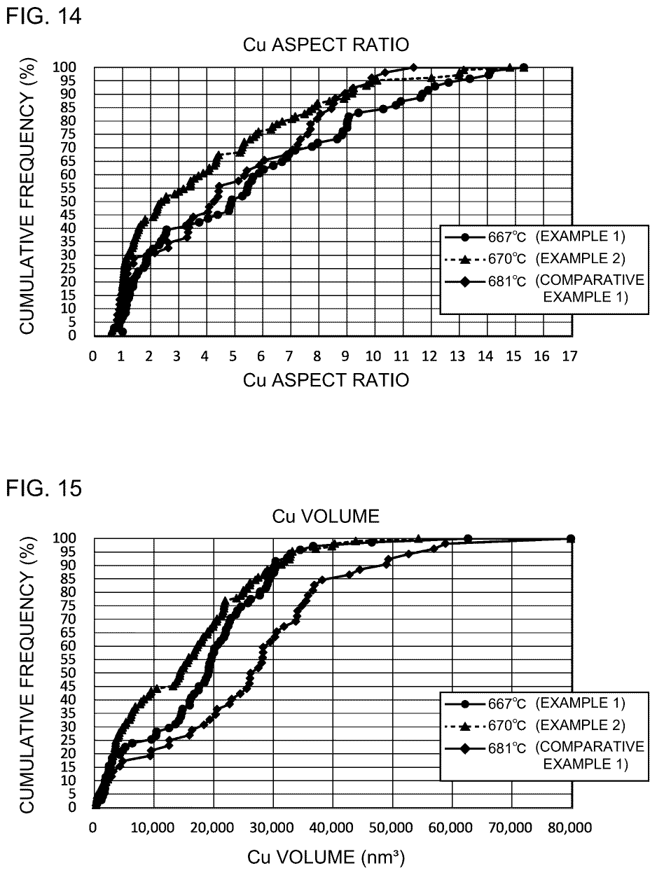

Since the metal aspect ratio has a large distribution, as shown in FIG. 14, creating and organizing a cumulative frequency line makes it easier to grasp the state of the distribution. For example, cumulative frequency 90% refers to the aspect ratio of the metal corresponding to 90% of the total number of metal microparticles when counting in order from the smallest aspect ratio. In other words, in this case, 10% of the number of metal microparticles have a metal aspect ratio greater than that, serving as an index to judge whether the extinction ratio at long wavelengths is high. The aspect ratio of the metal microparticles in the present embodiment, at a cumulative frequency of 90%, is preferably 6 or more and 16 or less, more preferably 9 or more, still more preferably 10 or more, and most preferably 11 or more.

Next, the volume ratio occupied by the metal microparticles 4 within the cavity 3 will be described. In the present embodiment, the total volume sum of one or a plurality of metal microparticles 4 contained within each cavity 3, with respect to the volume of the cavity 3, is preferably 12% or more and 25% or less as an average value, and more preferably 12% or more and 20% or less. The volume ratio can be rephrased as packing factor. Furthermore, at a cumulative frequency of 90%, it is preferably 17% or more and 27% or less, more preferably 18% or more and 25% or less, and still more preferably 18% or more and 24% or less. In the present embodiment, as described above, the average diameter d1 of the metal microparticle 4 was set small to 20 nm or less, and the particle diameter of the metal microparticle 4 at a cumulative frequency of 90% was set small to 30 nm or less. The number of metal microparticles 4 contained in each cavity 3 is from 1 to about 10 at most. In the present embodiment, the metal microparticles 4 fill about ⅕ or less of the inside of the cavity 3, and the remainder is the non-embedded portion. In this way, in the present embodiment, by reducing the average diameter d1 of the metal microparticle 4 and the particle diameter of the metal microparticle 4 at a cumulative frequency of 90%, and reducing the volume ratio of the metal microparticles 4 occupying the inside of the cavity 3, it becomes possible to effectively achieve a reduction in insertion loss.

### <Effects of the Present Embodiment>

According to the present embodiment, the extinction ratio can be increased, and the insertion loss can be reduced. Specifically, for light in a wavelength band of 1270 nm to 1650 nm, the insertion loss is preferably 0.204 dB or less.

Note that between the case where the wavelength of light is 1270 nm and the case where it is 1650 nm, the insertion loss is higher for the shorter wavelength of 1270 nm; this is because even if metal microparticles of the same shape exist in the transmission direction of linearly polarized light, the shorter wavelength has a smaller light amplitude and corresponds to larger-sized obstacles/absorbers, resulting in higher insertion loss than for longer wavelengths. Although the measurement distance was set to a close distance for the short wavelength of 1270 nm and a far distance for the long wavelength of 1650 nm, there is almost no difference in insertion loss due to the measurement distance, or even if there is a difference in insertion loss, the longer distance results in an increase of at most about 0.001 dB, indicating that the effect of measurement distance is almost negligible.

Furthermore, for light in a wavelength band of 1270 nm to 1650 nm, the extinction ratio at a measurement distance of 5 mm is preferably 38 dB or more, and more preferably 40 dB or more.

Note that between the case where the wavelength of light is 1270 nm and the case where it is 1650 nm, the extinction ratio can be made higher on the long wavelength side; this is because the distance of 300 mm between the polarizing element and the detector during measurement using long-wavelength light is longer than the distance of 5 mm between the polarizing element and the detector during measurement using short-wavelength light, making it less susceptible to the influence of re-emitted light from the polarizing element. When the wavelength of light is 1650 nm, the extinction ratio at a measurement distance of 300 mm can be made 50 dB or more, more preferably 54 dB or more, and still more preferably 56 dB or more.

As shown in the experiments described later, by adjusting the average diameter of the metal microparticles to 20 nm or less, insertion loss can be reduced, and a high extinction ratio can be obtained; when the wavelength of light is 1270 nm, the insertion loss can be made 0.204 dB or less, and the extinction ratio (measurement distance 5 mm) can be made 38 dB or more, allowing more excellent optical characteristics to be obtained.

### <Manufacturing Method of the Polarizing Element of the Present Embodiment>

The manufacturing method of the polarizing element of the present embodiment is broadly divided into (A) Preparation and melting of glass composition, (B) Precipitation process of metal halide microparticles, (C) Stretching process of glass substrate, and (D) Reduction process.

### [(A) Preparation and Melting of Glass Composition]

First, preparation of the glass composition is performed. As the glass containing Cu (that is, when the metal microparticle 4 is a copper particle), for example, SiO₂, H₃BO₃, Al(OH)₃, AlF₃, Y₂O₃, Na₂CO₃, NaCl, CuCl, SnO are used as glass raw materials. Furthermore, as the glass containing Ag (that is, when the metal microparticle 4 is a silver particle), for example, SiO₂, H₃BO₃, Al(OH)₃, LizCO₃, Na₂CO₃, K₂CO₃, KNO₃, ZrO₂, TiO₂, NaCl, NaBr, AgCl, AgBr are used as glass raw materials. This raw material glass is placed in a platinum crucible and melted at about 1300° C. to 1500° C. Thereafter, the glass is molded and slowly cooled to room temperature.

Hereby, the precursor composition (base material glass) described above can be obtained. Specifically, in the case of glass containing Cu, SiO₂ is about 50-65% by weight (wt %), B₂O₃ is about 15-25% by weight, Al₂O₃ is about 4-12% by weight, Y₂O₃ is about 1-5% by weight, NazO is about 5-15% by weight, Cl is about 0.2-1% by weight, F is 0.6-1.5% by weight, CuO is about 0.2-0.5% by weight, and SnO₂ is about 0.01-0.5% by weight. Furthermore, in the case of glass containing Ag, SiO₂ is about 50-65% by weight, B₂O₃ is about 15-25% by weight, Al₂O₃ is about 4-12% by weight, LizO is about 0.5-5% by weight, Na₂O is about 0.5-10% by weight, K₂O is about 0.5-10% by weight, ZrO₂ is about 0.5-10% by weight, TiO₂ is about 0.5-5% by weight, Cl is about 0.1-1% by weight, Br is about 0.1-1.5% by weight, and AgO is about 0.1-0.5% by weight.

### [(B) Precipitation Process of Metal Halide Microparticles]

The glass obtained in (A) above is held at a heat treatment temperature of 650° C. to 800° C. for several hours to about 20 hours (preferably, about 4 hours to 10 hours). To generate metal halide microparticles of an appropriate size, generally, a high heat treatment temperature is required when the heat treatment time is short, and a relatively low heat treatment temperature can be used when the heat treatment time is long.

For example, in a configuration where CuCl is included as a metal halide in the glass, by the above heat treatment, Cl ions and Cu ions aggregate, and liquid-state CuCl microparticles precipitate. In the subsequent cooling process, when the temperature of the glass decreases to around the glass transition temperature (Tg), for example, around 500° C., it is maintained in a glass state. Even in this state, CuCl exists as a liquid, but further, when the temperature of the glass decreases and falls below the melting point of CuCl, 430° C., CuCl undergoes a phase change from liquid to solid. Although not limited, the precipitated metal halide microparticles (CuCl) are formed as substantially spheres.

Furthermore, in a configuration where AgCl is included as a metal halide in the glass, by the above heat treatment, Cl ions, Br ions, and Ag ions aggregate, and liquid-state AgClBr microparticles precipitate. In the subsequent cooling process, when the temperature of the glass decreases to around the glass transition temperature (Tg), for example, around 500° C., it is maintained in a glass state. Even in this state, AgClBr exists as a liquid, but further, when the temperature of the glass decreases and falls below the melting point of AgClBr, 420-460° C., AgClBr undergoes a phase change from liquid to solid. Although not limited, the precipitated metal halide microparticles (AgClBr) are formed as substantially spheres. Note that AgClBr is, precisely, AgCl₍ₓ₎Br₍₁₋ₓ₎ ((<<1).

### [(C) Stretching Process of Glass Substrate]

Subsequently, the glass substrate in which the metal halide microparticles have precipitated is heated and stretched in one direction. In a configuration where CuCl is included as a metal halide in the glass, the heating temperature in this stretching process is, for example, 550° C. to 650° C., and the tension in this stretching process is, for example, about 34.3 MPa to 53.9 MPa. CuCl changes from solid to liquid by heat stretching, and again undergoes a phase change to solid when the temperature falls below the melting point of CuCl.

Furthermore, in a configuration where AgCl is included as a metal halide in the glass, the heating temperature in this stretching process is, for example, 550° C. to 650° C., and the tension in this stretching process is, for example, about 29.4 MPa to 63.7 MPa. AgClBr changes from solid to liquid by heat stretching, and again undergoes a phase change to solid when the temperature falls below the melting point of AgClBr.

By this stretching process, all metal halide microparticles change into an elongated shape stretched long in substantially the same direction.

### [(D) Reduction Process]

Subsequently, the glass substrate in which the metal halide has been extended long in one direction is reduced. The reduction process is performed at a temperature equal to or lower than the glass transition temperature (Tg), for example, under a hydrogen atmosphere. For this reason, the structure of the glass remains in the glass state, while the metal halide microparticles are reduced to metal microparticles. That is, if the metal halide microparticle is CuCl, it can be reduced to obtain Cu microparticles, and if the metal halide particle is AgClBr, it can be reduced to obtain Ag microparticles.

In this reduction process, the region of the metal halide microparticles extended long in one direction is maintained as is to become the cavity 3, and one or multiple divided metal microparticles 4 with small particle diameters are generated within the cavity 3.

Here, in the process of (B) above, if the precipitation temperature is increased, the volume of the precipitating metal halide microparticles becomes large, making it difficult to control the average diameter of the metal microparticles obtained by reducing the metal halide microparticles to be small. To obtain excellent optical characteristics, since it is desired to adjust the average diameter d1 of the metal microparticles to be 20 nm or less, in order to suppress the volume of the precipitating metal halide microparticles, in the case of Cu-containing glass, the heat treatment temperature in the precipitation process (B) was set within the range of 650° C. to 675° C. when the heat treatment time was 8 hours. Furthermore, in the case of Ag-containing glass, the heat treatment temperature in the precipitation process (B) was set within the range of 690° C. to 700° C. when the heat treatment time was 8 hours.

Hereby, the average diameter of the metal microparticle 4 can be easily and accurately adjusted to be 20 nm or less.

### <Use>

The polarizing element 1 of the present embodiment is applicable to any optical device in which a polarizing element is used, and its use is not particularly limited, but for example, it can be used as polarizing glass for pigtail-type optical isolators in the wavelength band used in optical communications.

### Examples

Hereinafter, the present embodiment will be described more specifically using

### Examples and Comparative Examples.

In the experiments, for each of the Cu-containing glass (Example 1, Example 2, Comparative Example 1) and Ag-containing glass (Example 3, Example 4) described above, (A) Preparation and melting of glass composition, (B) Precipitation process of metal halide microparticles, (C) Stretching process of glass substrate, and (D) Reduction process were performed, and the precipitated metal halide microparticles and metal microparticles were measured by TEM observation.

### <<Cu-Containing Glass>>

### [(A) Preparation and Melting of Glass Composition]

Using SiO₂, H₃BO₃, Al(OH)₃, AlF₃, Y₂O₃, Na₂CO₃, NaCl, CuCl, SnO as raw materials for the glass, this raw material glass was placed in a 3-liter platinum crucible, melted at about 1400° C., then poured into a metal mold for molding, and slowly cooled to room temperature to obtain a base material glass.

The composition (after melting) of the base material glass thus obtained was, in % by weight, SiO₂: 58.0, B₂O₃: 18.6, Al₂O₃: 8.2, Y₂O₃: 3.5, Na₂O: 9.3, CI: 0.7, F: 1.2, CuO: 0.4, SnO₂: 0.1.

### [(B) Precipitation Process of Metal Halide Microparticles]

The base material glass obtained in (A) above was heat-treated at 667° C., 670° C., and 681° C. for about 8 hours to precipitate CuCl microparticles in the glass, then cut into a size of width 120 mm, length 250 mm, thickness 6 mm to create a preform.

Hereinafter, the experimental sample with a heat treatment temperature of 667° C. will be described as Example 1, the experimental sample with a heat treatment temperature of 670° C. as Example 2, and the experimental sample with a heat treatment temperature of 681° C. as Comparative Example 1.

### [(C) Stretching Process of Glass Substrate]

Next, the preform obtained above was heated in a drawing furnace, and in the case of Example 1 and Example 2, it was stretched with a tension of 39.2 MPa, and in the case of Comparative Example 1, it was stretched with a tension of 26.5 MPa. Hereby, the plurality of metal halide microparticles (CuCl) contained in the glass changed from a spherical shape to an elongated shape (substantially ellipsoidal shape) extending long along the stretching direction.

Thus, the tension during stretching was about 1.5 in Example 1 and Example 2, when Comparative Example 1 is taken as 1. Since the particle diameter of CuCl microparticles in Example 1 and Example 2 is smaller compared to Comparative Example 1, a difference in tension was provided to appropriately stretch the CuCl microparticles and achieve an appropriate shape for the aspect ratio of the Cu microparticles generated in the reduction process described later.

### [(D) Reduction Process]

The approximately 0.6 mm thick glass film obtained in the stretching process of (C) above was polished to 0.2 mm thickness, then heat-treated in a hydrogen atmosphere at 440° C. for about 7 hours, reducing the CuCl microparticles stretched in one direction to metallic copper (hereinafter referred to as Cu microparticles).

### <Observation in TEM Photographs>

Each experimental sample was observed with a transmission electron microscope (TEM) photograph. The transmission electron microscope used was model number: JEM-2100F manufactured by JEOL Ltd. The acceleration voltage in the experiment was 200 kV, and the ion milling thin film preparation method was used for sample preparation.

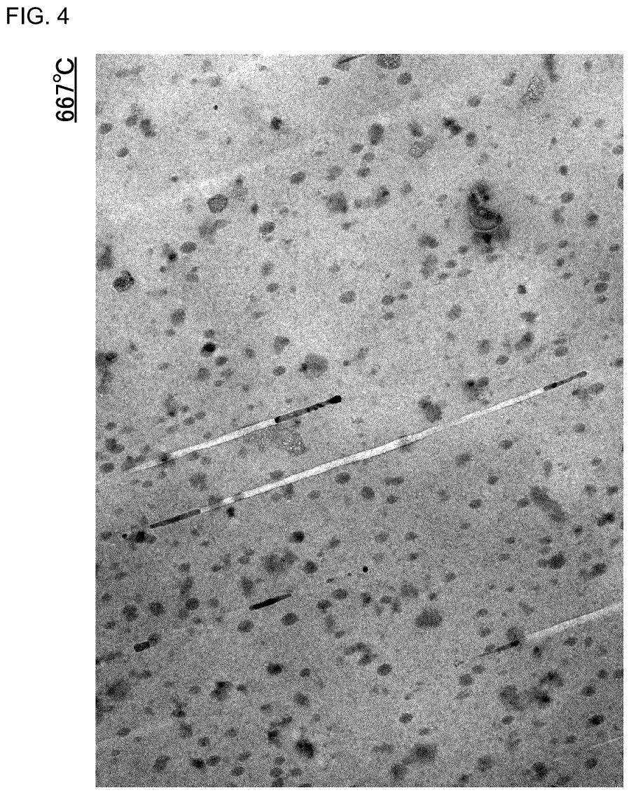

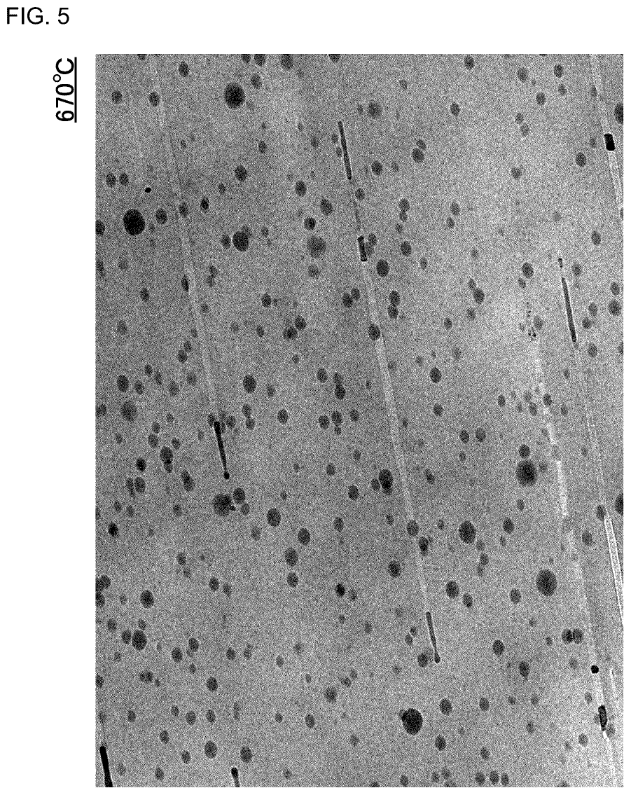

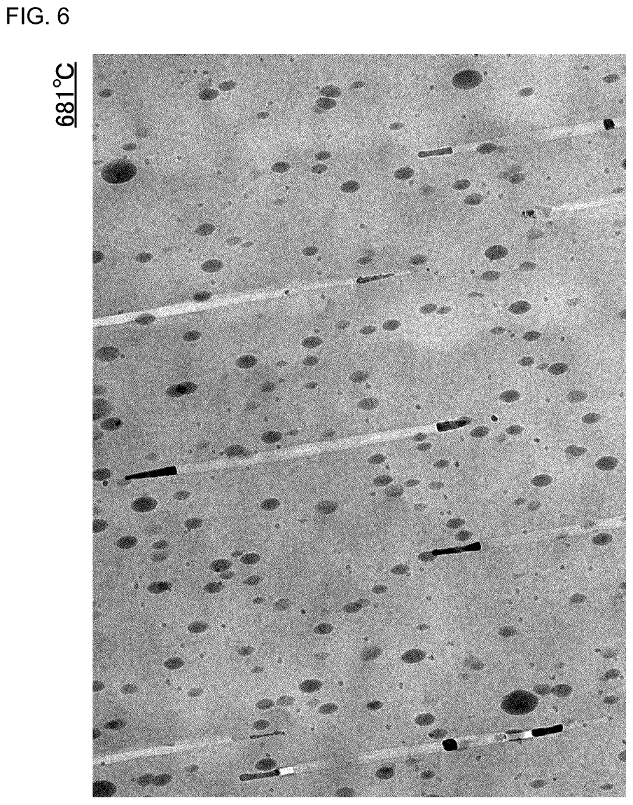

FIG. 4 is a partially enlarged view of a TEM photograph in Example 1 (heat treatment temperature in precipitation process was 667° C.), FIG. 5 is a partially enlarged view of a TEM photograph in Example 2 (heat treatment temperature in precipitation process was 670° C.), and FIG. 6 (heat treatment temperature at precipitation temperature was 681° C.) is a partially enlarged view of a TEM photograph in Comparative Example 1.

In all experimental examples, a plurality of elongated cavities were observed in the glass substrate. It was confirmed by EDS analysis performed simultaneously with TEM measurement that the areas appearing white in each photograph are cavities (non-embedded portions not filled with Cu microparticles), and the areas appearing black are Cu microparticles. Thus, within each cavity, Cu microparticles smaller than the volume of the cavity were observed. Many Cu microparticles were arranged closer to both end positions of the cavity, and some were also seen scattered spaced apart inward from the end positions.

The cavities observed in the TEM photographs shown in FIGS. 4 to 6 are traces of CuCl microparticles (metal halide particles) stretched in one direction during the stretching process. Note that in FIGS. 4 to 6, besides the regions indicating cavities and Cu microparticles, it can be seen that small dot-like portions of substantially elliptical shape with low flatness are scattered in a color slightly lighter than the black color indicating metal microparticles. However, these dot-like portions are not related to CuCl microparticles or Cu microparticles, and do not contribute to the extinction ratio or insertion loss of the polarizing glass.

### <Experiment Regarding Volume of Metal Halide Microparticles (CuCl Microparticles)>

In the experiment, the diameter-derived particle volumes of a plurality of metal halide microparticles appearing within an arbitrarily determined predetermined range of the TEM photograph were measured. Note that the observed number of metal halide microparticles was about 15 to 30.

The volume of the elongated cavity portion mentioned above (that is, the CuCl microparticle) was determined as follows. The volume V of the substantially spheroid was calculated from the formula:

$$V = ( 1 / 3 ) \times 4 π {r}_{1} \times {( r 2 / 2 )}^{2}$$

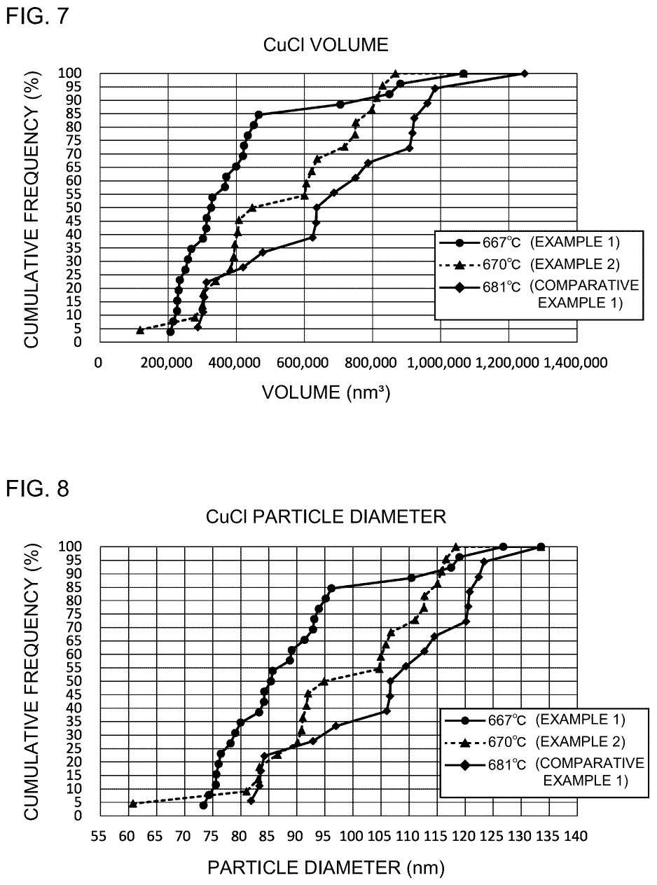

by measuring r₁ (half the length of the major axis) and 12 (length of the minor axis) from the TEM photograph. The experimental results are shown in FIG. 7.

FIG. 7 was created by arranging the volumes of the individual CuCl microparticles determined above in ascending order, with volume on the horizontal axis and cumulative frequency on the vertical axis.

As shown in FIG. 7, when observed at a cumulative frequency of 90%, the volume of CuCl microparticles in Example 1 was about 760,000 nm³, the volume of CuCl microparticles in Example 2 was about 810,000 nm³, and the volume of CuCl microparticles in Comparative Example 1 was about 970,000 nm³. Comparing by average value, the volume of CuCl microparticles in Example 1 was about 400,000 nm³, the volume of CuCl microparticles in Example 2 was about 530,000 nm³, and the volume of CuCl microparticles in Comparative Example 1 was about 680,000 nm³. Hereinafter, the average value and the magnitude at cumulative frequency 90% of the volume of CuCl microparticles in Example 1, Example 2, and Comparative Example 1 are summarized in Table 1.

TABLE 1
Unit (nm³)

| Example 1 | | Example 2 | | Comparative Example 1 | |
|---|---|---|---|---|---|
| 667° C. | | 670° C. | | 681° C. | |
| | 90% | | 90% | | 90% |
| Average | Cumulative | Average | Cumulative | Average | Cumulative |
| Value | Frequency | Value | Frequency | Value | Frequency |
| 404,991 | 762,651 | 534,431 | 809,031 | 675,544 | 965,333 |

In this way, the heat treatment temperature increased in the order of Example 1, Example 2, and Comparative Example 1, and the CuCl microparticle shape became larger in this order; therefore, the volume of the CuCl microparticles increased in the order of Example 1, Example 2, and Comparative Example 1.

### <Experiment Regarding Particle Diameter of Metal Halide Microparticles (CuCl Microparticles)>

Next, the individual volume V of the CuCl microparticles obtained above was converted to the diameter R (hereinafter referred to as particle diameter) of the substantially sphere before stretching using the following formula.

$$\begin{matrix}V = ( 1 / 3 ) \times 4 {π ( R / 2 )}^{3} \\ R = {( 6 V / π )}^{( 1 / 3 )}\end{matrix}$$

Similarly to FIG. 7, the obtained individual particle diameters were arranged in ascending order, and FIG. 8 was created with particle diameter on the horizontal axis and cumulative frequency on the vertical axis.

As shown in FIG. 8, the particle diameter of the CuCl microparticles became smaller in the order of lower heat treatment temperature in the precipitation process. Observed at a cumulative frequency of 90%, the particle diameter of CuCl microparticles in Example 1 was about 113 nm, Example 2 was about 116 nm, and Comparative Example 1 was about 123 nm. Furthermore, when the average diameter was calculated by summing the particle diameters of the samples and dividing by the number of samples, Example 1 was about 89 nm, Example 2 was about 99 nm, and Comparative Example 1 was about 107 nm. Hereinafter, the average value and the magnitude at cumulative frequency 90% of the particle diameter of CuCl microparticles in Example 1, Example 2, and Comparative Example 1 are summarized in Table 2.

TABLE 2
Unit (nm)

| Example 1 | | Example 2 | | Comparative Example 1 | |
|---|---|---|---|---|---|
| 667° C. | | 670° C. | | 681° C. | |
| | 90% | | 90% | | 90% |
| Average | Cumulative | Average | Cumulative | Average | Cumulative |
| Value | Frequency | Value | Frequency | Value | Frequency |
| 89.44 | 113.25 | 98.63 | 115.61 | 106.64 | 122.62 |

It was found that the higher the heat treatment temperature in the precipitation process, the more easily CuCl microparticles precipitate, and the larger the particle diameter of CuCl becomes.

### <Experiment Regarding Aspect Ratio of Metal Halide Microparticles (CuCl Microparticles)>

The aspect ratio of CuCl after the stretching process, where the longitudinal direction is oriented in one direction, was determined. The aspect ratio was determined by: length in the direction along the stretching direction/length in the direction orthogonal to the stretching direction. The direction along the stretching direction is the longitudinal direction. A larger numerical value of the aspect ratio indicates a more elongated microparticle.

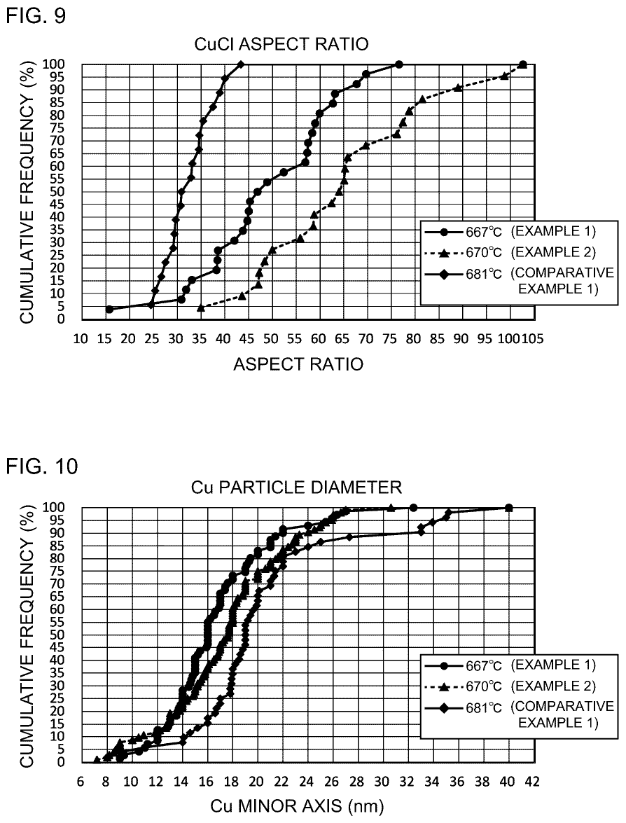

The obtained individual aspect ratios were arranged in ascending order, and FIG. 9 was created with particle diameter on the horizontal axis and cumulative frequency on the vertical axis. As shown in FIG. 9, observed at a cumulative frequency of 90%, the aspect ratio of CuCl microparticles in Example 1 was about 65, the aspect ratio of CuCl microparticles in Example 2 was about 88, and the aspect ratio of CuCl microparticles in Comparative Example 1 was about 39. Observed by the average value of the aspect ratio, Example 1 was about 49, Example 2 was about 65, and Comparative Example 1 was about 32. Hereinafter, the average value and the magnitude at cumulative frequency 90% of the aspect ratio of CuCl microparticles in Example 1, Example 2, and Comparative Example 1 are summarized in Table 3.

TABLE 3

| Example 1 | | Example 2 | | Comparative Example 1 | |
|---|---|---|---|---|---|
| 667° C. | | 670° C. | | 681° C. | |
| | 90% | | 90% | | 90% |
| Average | Cumulative | Average | Cumulative | Average | Cumulative |
| Value | Frequency | Value | Frequency | Value | Frequency |
| 49.40 | 64.97 | 65.49 | 87.51 | 32.46 | 39.12 |

Thus, comparing Example 1 and Example 2 stretched with the same tension, the aspect ratio of CuCl microparticles is larger in Example 2 than in Example 1: this is because the particle diameter of CuCl microparticles in Example 2 is larger than in Example 1, and when stretched with the same tension as Example 1, the CuCl microparticles were stretched more significantly.

Above, the experimental results for the volume, particle diameter, and aspect ratio of metal halide microparticles (CuCl microparticles) were considered based on measurements from TEM photographs of the polarizing glass product after the (D) reduction process; for example, the volume of the substantially spherical CuCl before stretching and the volume of the substantially spheroid shape CuCl after stretching can be regarded as equal, and also, the CuCl aspect ratio after stretching and before reduction and the CuCl aspect ratio after reduction can be regarded as equal.

### <Experiment Regarding Particle Diameter of Metal Microparticles (Cu Microparticles)>

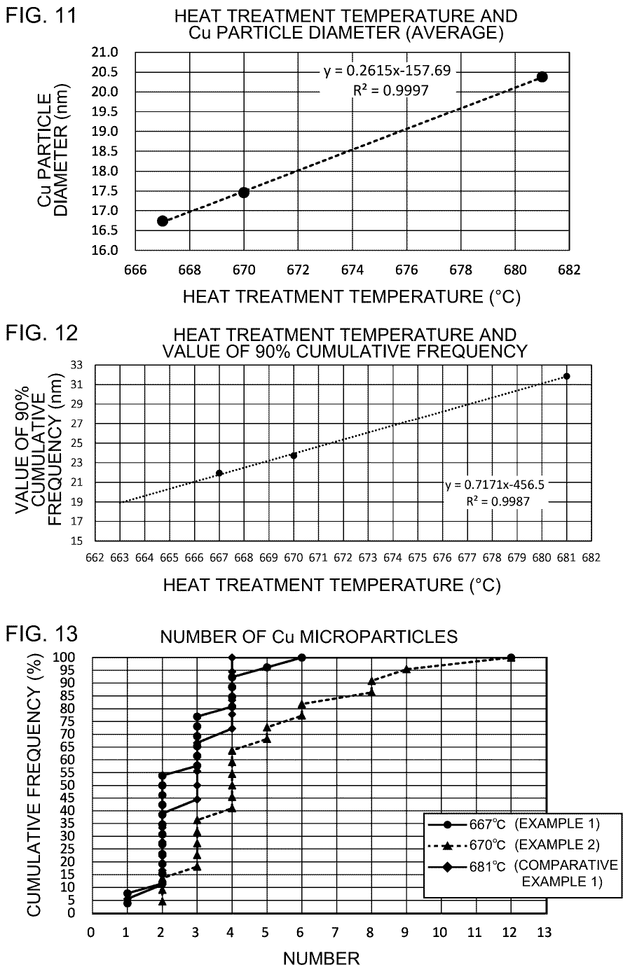

In the experiment, for each experimental sample, the particle diameter of metal microparticles (Cu microparticles) appearing within a predetermined range was measured using TEM photographs. As shown in FIG. 3, the particle diameter d1 of the metal microparticle 4 was determined in the direction (Y direction) orthogonal to the longitudinal direction (X direction) of the cavity 3, at half the length of the longitudinal direction (L/2), or at the center position in the longitudinal direction. Individual Cu metal particle diameters were arranged in ascending order, with Cu particle diameter on the horizontal axis and cumulative frequency on the vertical axis, and the cumulative frequency line of Cu metal particle diameter is shown in FIG. 10. Note that the observed number of metal microparticles was about 50 to 100. Furthermore, FIG. 11 is a graph showing the relationship between the heat treatment temperature of the precipitation process and the average value of the particle diameter of Cu microparticles. As shown in FIG. 11, it was found that the heat treatment temperature of the precipitation process and the average value of the particle diameter of Cu microparticles have a substantially linear relationship. Furthermore, FIG. 12 is a graph showing the relationship between the heat treatment temperature and the particle diameter at a cumulative frequency of 90% of metal microparticles. As shown in FIG. 12, it was found that the heat treatment temperature of the precipitation process and the particle diameter (cumulative frequency 90%) of Cu microparticles have a substantially linear relationship.

As shown in FIGS. 10 to 12, the particle diameter of Cu microparticles became larger as the heat treatment temperature in the precipitation process was higher. Namely, the particle diameter of Cu microparticles increased in the order of Example 1<Example 2<Comparative Example 1. This is because the particle diameter of the originally precipitated CuCl microparticles is larger as the heat treatment temperature is higher, and therefore, even after reduction, the particle diameter of Cu microparticles increases in the order of the heat treatment temperature.

As shown in FIGS. 10 and 12, the particle diameter of Cu microparticles in Example 1, at a cumulative frequency of 90%, was about 22 nm, the particle diameter of Cu microparticles in Example 2 was about 24 nm, and the particle diameter of Cu microparticles in Comparative Example 1 was about 32 nm. Furthermore, when the average value was measured by summing the particle diameters of the samples and dividing by the number of samples, as shown in FIG. 11, the average diameter of Cu microparticles in Example 1 was about 16.7 nm, the average diameter of Cu microparticles in Example 2 was about 17.5 nm, and the average diameter of Cu microparticles in Comparative Example 1 was about 20.4 nm. Hereinafter, the average value and the magnitude at cumulative frequency 90% of the particle diameter of Cu microparticles in Example 1, Example 2, and Comparative Example 1 are summarized in Table 4.

TABLE 4
Unit (nm)

| Example 1 | | Example 2 | | Comparative Example 1 | |
|---|---|---|---|---|---|
| 667° C. | | 670° C. | | 681° C. | |
| | 90% | | 90% | | 90% |
| Average | Cumulative | Average | Cumulative | Average | Cumulative |
| Value | Frequency | Value | Frequency | Value | Frequency |
| 16.74 | 21.94 | 17.46 | 23.72 | 20.38 | 31.86 |

<Experiment Regarding Number of Cu Microparticles Contained in Cavities Associated with Metal Microparticles (Cu Microparticles)>

The number of Cu microparticles contained in the cavities was determined from TEM photographs. FIG. 13 shows the relationship between the number of Cu microparticles and cumulative frequency. The average value of the number of Cu microparticles was 2.7 in Example 1, 4.7 in Example 2, and 2.9 in Comparative Example 1. At cumulative frequency 90%, it was 4 in Example 1, 8 in Example 2, and 4 in Comparative Example 1. Hereinafter, the average value and the magnitude at cumulative frequency 90% of the number of Cu microparticles in Example 1, Example 2, and Comparative Example 1 are summarized in Table 5.

TABLE 5
Unit (Counts)

| Example 1 | | Example 2 | | Comparative Example 1 | |
|---|---|---|---|---|---|
| 667° C. | | 670° C. | | 681° C. | |
| | 90% | | 90% | | 90% |
| Average | Cumulative | Average | Cumulative | Average | Cumulative |
| Value | Frequency | Value | Frequency | Value | Frequency |
| 2.73 | 4.0 | 4.73 | 8.0 | 2.89 | 4.0 |

In Example 1 and Example 2, the glass was stretched with the same tension, but since the particle diameter of CuCl microparticles was larger in Example 2 than in Example 1, CuCl was stretched more significantly in Example 2 than in Example 1; consequently, more Cu microparticles were divided within one cavity after reduction, and the number of Cu microparticles became larger in Example 2 than in Example 1.

### <Experiment Regarding Aspect Ratio of Metal Microparticles (Cu Microparticles)>

The aspect ratio of the metal microparticles (Cu microparticles) was determined. It was determined by the length of the Cu microparticle in the direction along the stretching direction of the cavity/the short axis diameter of the Cu microparticle. The aspect ratio of the Cu microparticle can be determined by L/d1 in FIG. 3. FIG. 14 shows the relationship between aspect ratio and cumulative frequency.

As shown in FIG. 14, looking at the aspect ratio of Cu microparticles at cumulative frequency 90%, the aspect ratio of Cu microparticles in Example 1 was about 11.7, the aspect ratio of Cu microparticles in Example 2 was about 9.1, and the aspect ratio of Cu microparticles in Comparative Example 1 was about 8.9. Furthermore, when the average value was measured, the aspect ratio of Cu microparticles in Example 1 was about 5.5, the aspect ratio of Cu microparticles in Example 2 was about 3.9, and the aspect ratio particle diameter of Cu microparticles in Comparative Example 1 was about 4.7. Hereinafter, the average value and the magnitude at cumulative frequency 90% of the aspect ratio of Cu microparticles in Example 1, Example 2, and Comparative Example 1 are summarized in Table 6.

TABLE 6

| Example 1 | | Example 2 | | Comparative Example 1 | |
|---|---|---|---|---|---|
| 667° C. | | 670° C. | | 681° C. | |
| | 90% | | 90% | | 90% |
| Average | Cumulative | Average | Cumulative | Average | Cumulative |
| Value | Frequency | Value | Frequency | Value | Frequency |
| 5.54 | 11.68 | 3.93 | 9.09 | 4.72 | 8.86 |

Looking at the average value, the aspect ratio of Cu microparticles in Example 2 became smaller than the aspect ratio of Cu microparticles in Example 1. This is because, as described above, more Cu microparticles were divided within one cavity in Example 2 than in Example 1, resulting in the aspect ratio of Cu microparticles being smaller in Example 2 than in Example 1.

Looking at cumulative frequency 90%, the aspect ratio of Cu microparticles was larger in Example 1 and Example 2, which were stretched at 1.5 times the tension of Comparative Example 1, than in Comparative Example 1. As described previously, it was found from FIG. 14 that Cu microparticles having an aspect ratio of 11 or more, which is most preferable for obtaining a high extinction ratio at long wavelengths, are more numerous in Example 1 and Example 2 stretched with 1.5 times the tension, compared to Comparative Example 1.

### <Experiment Regarding Volume of Metal Microparticles (Cu Microparticles)>

The volume of the metal microparticles (Cu microparticles) was determined based on the particle diameter of the Cu microparticles obtained in FIG. 10. Assuming the Cu microparticle has a substantially truncated cone shape as shown in FIG. 3, or a shape combining two truncated cones, the volume of the Cu microparticle can be determined by the above formula (2).

FIG. 15 shows the relationship between the volume of Cu microparticles and cumulative frequency. As shown in FIG. 15, the volume of Cu microparticles in Example 1 was about 30,300 nm³, the volume of Cu microparticles in Example 2 was about 30,700 nm³, and the volume of Cu microparticles in Comparative Example 1 was about 48,100 nm³. All are values at cumulative frequency 90%. Furthermore, the volume of Cu microparticles is the volume per single Cu microparticle. The average value of the volume per single Cu microparticle was about 18,200 nm³ in Example 1, about 14,900 nm³ in Example 2, and about 26,300 nm³ in Comparative Example 1. Hereinafter, the average value and the magnitude at cumulative frequency 90% of the volume of Cu microparticles in Example 1, Example 2, and Comparative Example 1 are summarized in Table 7.

TABLE 7
Unit (nm³)

| Example 1 | | Example 2 | | Comparative Example 1 | |
|---|---|---|---|---|---|
| 667° C. | | 670° C. | | 681° C. | |
| | 90% | | 90% | | 90% |
| Average | Cumulative | Average | Cumulative | Average | Cumulative |
| Value | Frequency | Value | Frequency | Value | Frequency |
| 18,176 | 30,333 | 14,855 | 30,703 | 26,256 | 48,055 |

In terms of the average value of the volume of Cu microparticles, Example 2 became smaller than Example 1: this is attributed to the fact that, as described above, the CuCl particle diameter was larger in Example 2 than in Example 1, and when stretched with the same tension, it was stretched more elongatedly, resulting in the number of Cu metal particles within one CuCl microparticle after reduction becoming approximately twice as large as in Example 1, consequently reducing the volume per single Cu metal microparticle.

### <Experiment Regarding Volume Ratio of Metal Microparticles (Cu Microparticles)>

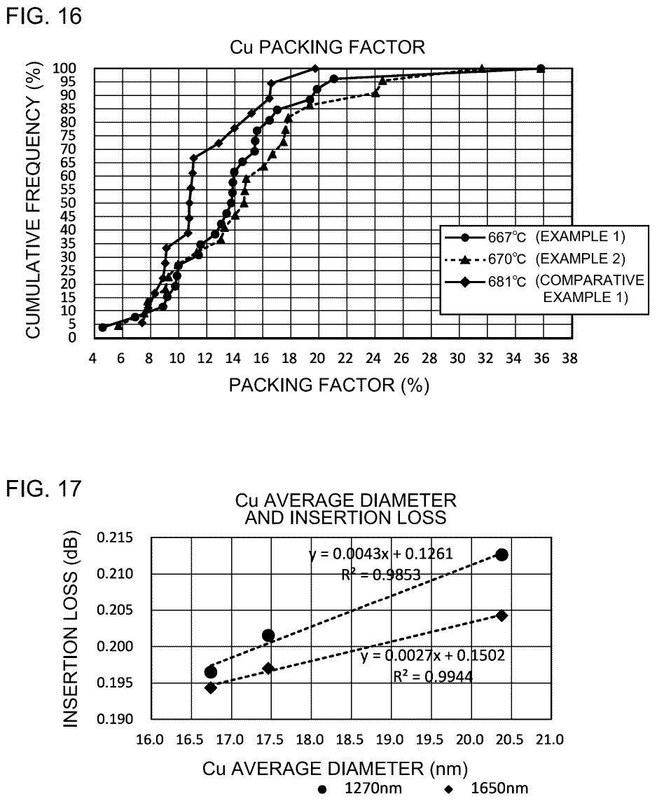

The volume ratio of Cu microparticles relative to the volume of the cavity was determined. In the experiment, the ratio of the sum of the volumes of all Cu microparticles existing in one cavity (trace of CuCl microparticle) to the volume of that cavity ([Sum of volumes of Cu microparticles/Volume of cavity]×100(%)) was determined. This can also be called the packing factor. This Cu microparticle volume ratio was determined for all cavities appearing within a predetermined range. The experimental results are shown in FIG. 16.

As shown in FIG. 16, the packing factor of the metal microparticles (Cu microparticles) was about 20% for Example 1, about 23% for Example 2, and 17% for Comparative Example 1. All are values at cumulative frequency 90%. Furthermore, when the average value was measured, the packing factor of the metal microparticles (Cu microparticles) in Example 1 was 14%, the packing factor of the metal microparticles (Cu microparticles) in Example 2 was 15%, and the packing factor of the metal microparticles (Cu microparticles) in Comparative Example 1 was 12%. Hereinafter, the average value and the magnitude at cumulative frequency 90% of the packing factor of Cu microparticles in Example 1, Example 2, and Comparative Example 1 are summarized in Table 8.

TABLE 8
Unit (%)

| Example 1 | | Example 2 | | Comparative Example 1 | |
|---|---|---|---|---|---|
| 667° C. | | 670° C. | | 681° C. | |
| | 90% | | 90% | | 90% |
| Average | Cumulative | Average | Cumulative | Average | Cumulative |
| Value | Frequency | Value | Frequency | Value | Frequency |
| 14.12 | 19.56 | 15.01 | 23.10 | 11.69 | 16.50 |

Thus, the packing factor was larger in Example 1 and Example 2 than in Comparative Example 1.

### <Experiment Regarding Insertion Loss and Extinction Ratio>

Using the polarizing glasses of Examples 1, 2 and Comparative Example 1 obtained above, insertion loss and extinction ratio were determined. In the experiment, after the (C) stretching process of the glass substrate, both surfaces were polished to a thickness of 0.2 mmt, then the (D) reduction process was performed, and further, an anti-reflection film (AR coat) was applied to one surface of the polarizing glass to reduce reflectance due to the refractive index of the polarizing glass. The anti-reflection film was formed with a multilayer film composed of metal oxide layers such as TiO₂ and Ta₂O₅ and SiO₂ layers. Polarizing glass used in optical isolators is often used with a 0-degree product bonded to one surface of a Faraday element (garnet) and a 45-degree product bonded to the other surface with adhesive, thus only one surface is often exposed to the atmosphere. For the reasons above, the AR film of the polarizing glass was provided only on one surface. A semiconductor laser light source and a Glan-Thompson prism were arranged on one side of the polarizing glass, and a detector (power meter) was arranged on the other side of the polarizing glass. The Glan-Thompson prism is inserted to obtain a linearly polarized wave in a specific direction.

The polarizing glass was rotated, the minimum transmitted light intensity P₁ was measured, the polarizing glass was rotated 90 degrees, the maximum transmitted light intensity P₂ was measured, and the extinction ratio was determined by the following formula.

$$Extinction Ratio ( dB ) = - 10 Log ( {P}_{1} / {P}_{2} )$$

Insertion loss was determined by measuring the light intensity P₀ without the polarizing glass and using the following formula.

$$Insertion Loss ( d B ) = - 10 Log ( {P}_{2} / {P}_{0} )$$

The wavelengths of the laser light source were set to 1270 nm and 1650 nm; for the wavelength of 1270 nm, the distance between the polarizing glass and the detector was set to 5 mm, and for the wavelength of 1650 nm, the distance between the polarizing glass and the detector was set to 300 mm.

FIG. 17 is a graph showing the relationship between the average diameter of Cu microparticles and insertion loss. As shown in FIG. 17, it was found that the smaller the average diameter of Cu microparticles, the more the insertion loss can be reduced.

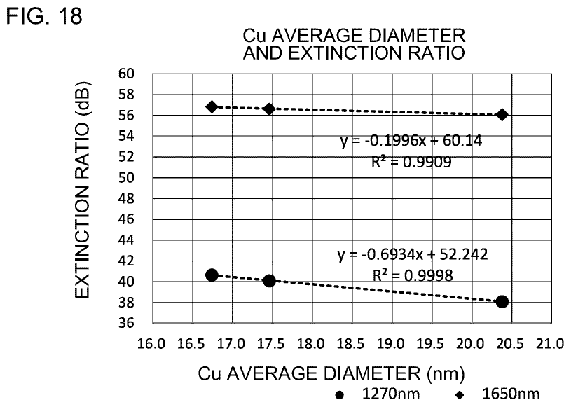

Furthermore, FIG. 18 is a graph showing the relationship between the average diameter of Cu microparticles and extinction ratio. As shown in FIG. 18, it was found that the smaller the average diameter of Cu microparticles, the higher the extinction ratio can be made.

From this, it was found that by making the Cu microparticles smaller, insertion loss can be reduced, and the extinction ratio can be increased.

As shown in FIG. 17, Comparative Example 1 exceeds 0.2 dB in insertion loss, while Example 1 and Example 2 could suppress the insertion loss for light of wavelengths 1270 nm and 1650 nm to 0.204 dB or less, and preferably, it was found that it can be suppressed to 0.197 dB or less. Furthermore, from the experimental results shown in FIG. 18, it was found that the extinction ratio can be made 40 dB or more at a measurement distance of 5 mm.

Based on the above, in the present example, the average diameter of Cu microparticles was set to 20 nm or less, with a preferred range of 10 nm or more and 18 nm or less, and a most preferred range set to 10 nm or more and 17 nm or less.

Although the lower limit value of the average value of Cu microparticles is not limited, for small metal halide microparticles such that the average diameter of Cu microparticles is less than 10 nm, even if the stretching tension is considerably increased, the aspect ratio of the Cu metal becomes small, and a predetermined extinction ratio cannot be obtained. That is, even when stretched with such a large stretching tension that breakage during stretching is unavoidable, if the average diameter of Cu microparticles is less than 10 nm, the aspect ratio of the Cu metal required to obtain the desired extinction ratio cannot be obtained; therefore, the lower limit of the preferred average diameter of Cu microparticles was set to 10 nm.

In the present example, the value at cumulative frequency 90% of the Cu microparticle particle diameter was set to 30 nm or less, with a preferred range of 12 nm or more and 26 nm or less, and a most preferred range set to 12 nm or more and 23 nm or less. The lower limit value of 12 nm in this case was set for the same reason as the lower limit value of the average diameter of the Cu metal mentioned above.

Furthermore, considering the aspect ratio of CuCl microparticles in Table 3 and the packing factor in Table 8, it was found that to produce polarizing glass with low insertion loss, the cavities need to be stretched to some extent, and the packing factor needs to be increased above a certain level.

Regarding the correlation between the CuCl aspect ratio in FIG. 9 and the Cu packing factor in FIG. 16, it can be seen that the order of magnitude of the cumulative frequency lines is the same, and the shapes of the lines are also similar. In Comparative Example 1 (681° C. heat-treated product), the CuCl aspect ratio was low (not stretched much), and the packing factor also became low. On the other hand, in Example 2 (670° C. heat-treated product), even when stretched with the same high tension, the CuCl particle diameter was larger than in Example 1 (667° C. heat-treated product), thus the CuCl aspect ratio became larger than in Example 1, and the packing factor also became the largest.

Comparative Example 1 has an average diameter of metal microparticles of 20 nm or more, and a particle diameter of metal microparticles at cumulative frequency 90% of 30 nm or more, resulting in high insertion loss; therefore, the preferred CuCl aspect ratio was set to 35 or more as an average value, and 45 or more at cumulative frequency 90% (see Table 3). Furthermore, it was determined preferable that the ratio of the total volume sum of metal microparticles within one cavity is 12% or more as an average value, and the value at cumulative frequency 90% is 17% or more. (see Table 8)

### <<Ag-Containing Glass>>

### [(A) Preparation and Melting of Glass Composition]

Using SiO₂, H₃BO₃, Al(OH)₃, Li₂CO₃, Na₂CO₃, K₂CO₃, KNO₃, ZrO₂, TiO₂, NaCl, NaBr, AgCl, AgBr as glass raw materials, these raw materials were placed in a 3-liter platinum crucible, melted at about 1450° C., then poured into a metal mold for molding, and slowly cooled to room temperature to obtain a base material glass.

The composition (after melting) of the base material glass thus obtained was, in % by weight, SiO₂: 57.0, B₂O₃: 17.0, Al₂O₃: 7.0, Li₂O: 1.9, Na₂O: 4.0, K₂O: 6.0, ZrO₂; 4.8, TiO₂: 1.4, Ag: 0.3, CI: 0.3, Br: 0.3.

### [(B) Precipitation Process of Metal Halide Microparticles]

The base material glass obtained in (A) above was heat-treated at 692° C. and 700° C. for about 8 hours to precipitate AgClBr microparticles in the glass, then cut into a size of width 120 mm, length 250 mm, thickness 6 mm to create a preform.

Hereinafter, the experimental sample with a heat treatment temperature of 692° C. will be described as Example 3, and the experimental sample with a heat treatment temperature of 700° C. as Example 4.

### [(C) Stretching Process of Glass Substrate]

Next, the preform obtained above was heated in a drawing furnace, and for Example 3, it was stretched with a tension of 60.3 MPa, and for Example 4, it was stretched with a tension of 33.7 MPa. Hereby, the plurality of metal halide microparticles (AgClBr) contained in the glass changed from a spherical shape to an elongated shape (substantially ellipsoidal shape) extending long along the stretching direction.

### [(D) Reduction Process]

The approximately 0.6 mm thick glass film obtained in the stretching process of (C) above was polished to 0.2 mm thickness, then heat-treated in a hydrogen atmosphere at 440° C. for about 7 hours, reducing the AgClBr microparticles stretched in one direction to metallic silver (hereinafter referred to as Ag microparticles).

### <Observation in TEM Photographs>

Each experimental sample was observed with a transmission electron microscope (TEM) photograph, similar to Example 1, Example 2, and Comparative Example 1 above.

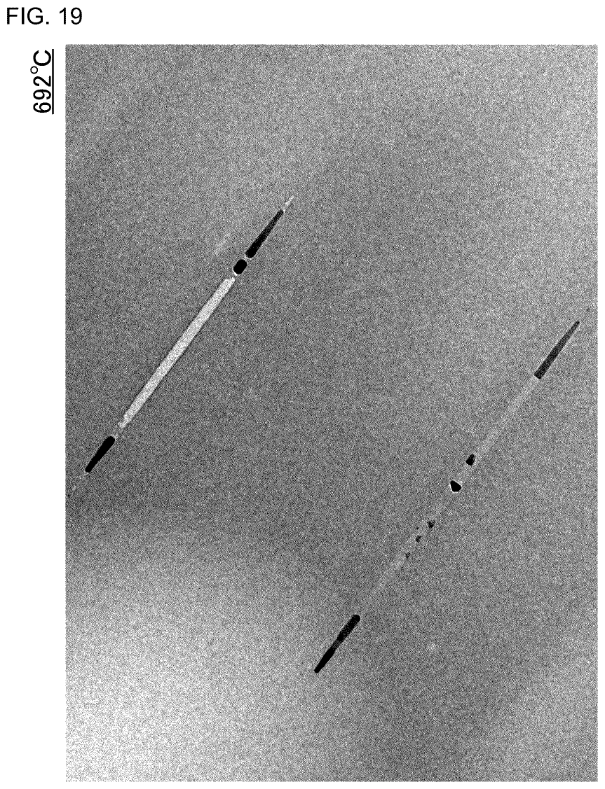

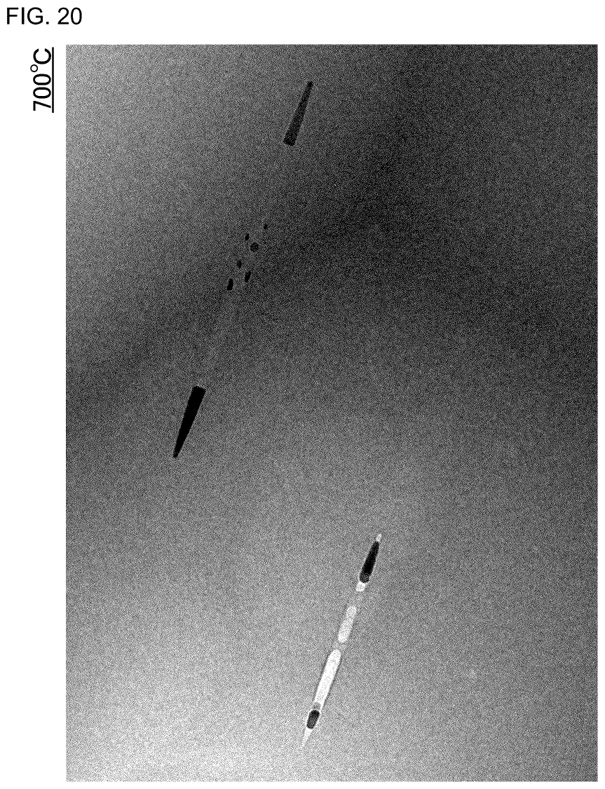

FIG. 19 is a partially enlarged view of a TEM photograph in Example 3 (heat treatment temperature in precipitation process was 692° C.), and FIG. 20 is a partially enlarged view of a TEM photograph in Example 4 (heat treatment temperature in precipitation process was 700° C.).

In both experimental examples, a plurality of elongated cavities were observed in the glass substrate. It was confirmed by EDS analysis performed simultaneously with TEM measurement that the areas appearing white in each photograph are cavities (non-embedded portions not filled with Ag microparticles), and the areas appearing black are Ag microparticles. Thus, within each cavity, Ag microparticles smaller than the volume of the cavity were observed. Many Ag microparticles were arranged closer to both end positions of the cavity, and some were also seen scattered spaced apart inward from the end positions.

The cavities observed in the TEM photographs shown in FIGS. 19 and 20 are traces of AgClBr microparticles (metal halide particles) stretched in one direction during the stretching process.

### <Experiment Regarding Volume of Metal Halide Microparticles (AgClBr Microparticles)>

In the experiment, similar to Example 1, Example 2, and Comparative Example 1 above, the diameter-derived particle volumes of a plurality of metal halide microparticles appearing within an arbitrarily determined predetermined range of the TEM photograph were measured.

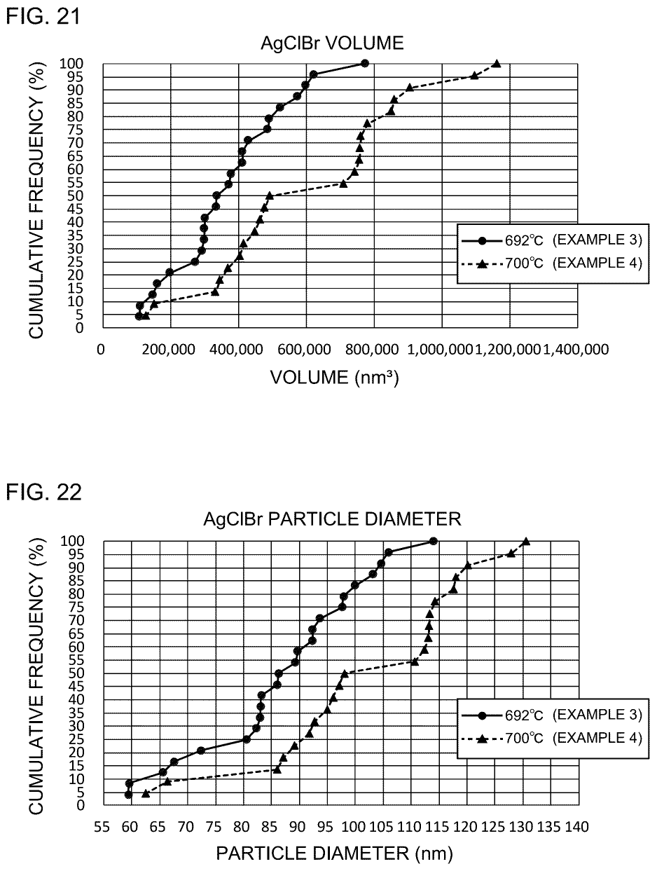

Note that the volume of the elongated cavity portion mentioned above (that is, the AgClBr microparticle) was determined similarly to Example 1, Example 2, and Comparative Example 1 above. The experimental results are shown in FIG. 21.

FIG. 21 was created by arranging the volumes of the individual AgClBr microparticles determined above in ascending order, with volume on the horizontal axis and cumulative frequency on the vertical axis.

As shown in FIG. 21, observed at a cumulative frequency of 90%, the volume of AgClBr microparticles in Example 3 was about 590,000 nm³, and the volume of AgClBr microparticles in Example 4 was about 900,000 nm³. Comparing by average value, the volume of AgClBr microparticles in Example 3 was about 370,000 nm³, and the volume of AgClBr microparticles in Example 4 was about 610,000 nm³. Hereinafter, the average value and the magnitude at cumulative frequency 90% of the volume of AgClBr microparticles in Example 3 and Example 4 are summarized in Table 9.

TABLE 9
Unit (nm³)

| | |
|---|---|
| Example 3 | Example 4 |
| 692° C. | 700° C. |

| | 90% | | 90% |
|---|---|---|---|
| Average | Cumulative | Average | Cumulative |
| Value | Frequency | Value | Frequency |
| 372,475 | 589,185 | 610,391 | 897,804 |

Thus, the heat treatment temperature was higher in Example 4 than in Example 3, and the AgClBr microparticle shape was larger in Example 4 than in Example 3; therefore, the volume of AgClBr microparticles also became larger in Example 4 than in Example 3.

### <Experiment Regarding Particle Diameter of Metal Halide Microparticles (AgClBr Microparticles)>

Next, regarding the individual volume V of the AgClBr microparticles obtained above, conversion was performed similarly to Example 1, Example 2, and Comparative Example 1, and similarly to FIG. 21, the obtained individual particle diameters were arranged in ascending order, and FIG. 22 was created with particle diameter on the horizontal axis and cumulative frequency on the vertical axis.

As shown in FIG. 22, the particle diameter of AgClBr microparticles was larger in Example 4, which had a higher heat treatment temperature in the precipitation process, than in Example 3. Observed at a cumulative frequency of 90%, the particle diameter of AgClBr microparticles in Example 3 was about 104 nm, and the particle diameter of AgClBr microparticles in Example 4 was about 120 nm. Furthermore, when the average diameter was calculated by summing the particle diameters of the samples and dividing by the number of samples, Example 3 was about 87 nm, and Example 4 was about 102 nm. Hereinafter, the average value and the magnitude at cumulative frequency 90% of the particle diameter of AgClBr microparticles in Example 3 and Example 4 are summarized in Table 10.

TABLE 10
Unit (nm)

| | |
|---|---|
| Example 3 | Example 4 |
| 692° C. | 700° C. |

| | 90% | | 90% |
|---|---|---|---|
| Average | Cumulative | Average | Cumulative |
| Value | Frequency | Value | Frequency |
| 87.05 | 104.01 | 102.39 | 119.69 |

It was found that the higher the heat treatment temperature in the precipitation process, the more easily AgClBr microparticles precipitate, and the larger the particle diameter of AgClBr becomes.

### <Experiment Regarding Aspect Ratio of Metal Halide Microparticles (AgClBr Microparticles)>

Similar to Example 1, Example 2, and Comparative Example 1 above, the aspect ratio of AgClBr after the stretching process, where the longitudinal direction is oriented in one direction, was determined.

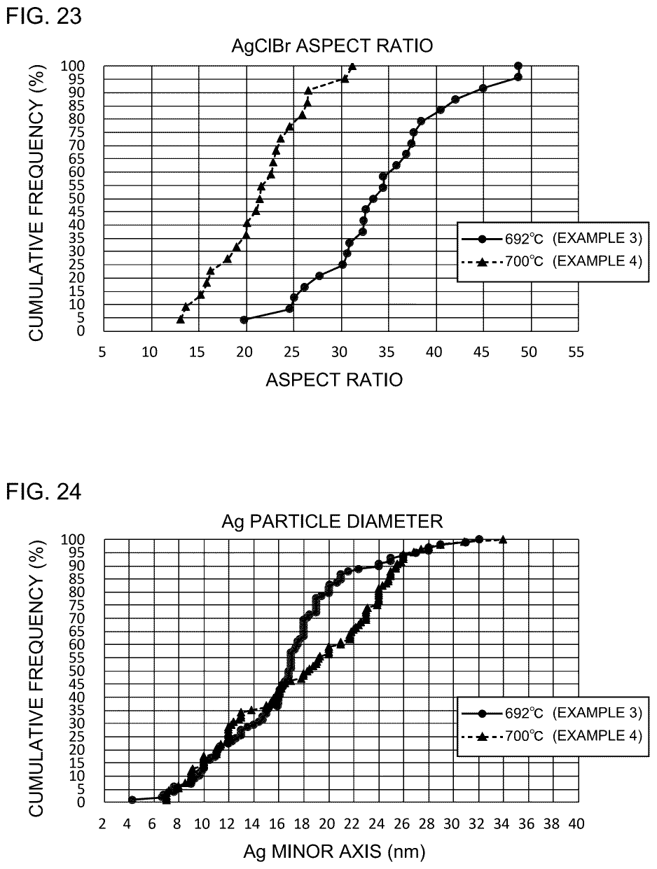

The obtained individual aspect ratios were arranged in ascending order, and FIG. 23 was created with particle diameter on the horizontal axis and cumulative frequency on the vertical axis. As shown in FIG. 23, observed at a cumulative frequency of 90%, the aspect ratio of AgClBr microparticles in Example 3 was about 44, and the aspect ratio of AgClBr microparticles in Example 4 was about 27. Observed by the average value of the aspect ratio, Example 3 was about 34, and Example 4 was about 21. Hereinafter, the average value and the magnitude at cumulative frequency 90% of the aspect ratio of AgClBr microparticles in Example 3 and Example 4 are summarized in Table 11.

TABLE 11

| | |
|---|---|
| Example 3 | Example 4 |
| 692° C. | 700° C. |

| | 90% | | 90% |
|---|---|---|---|
| Average | Cumulative | Average | Cumulative |
| Value | Frequency | Value | Frequency |
| 34.41 | 43.85 | 21.48 | 26.53 |

Thus, comparing Example 3 and Example 4, the aspect ratio of AgClBr microparticles is larger in Example 3 than in Example 4: this is because Example 3 was stretched with a larger tension than Example 4, causing the AgClBr microparticles to be stretched more significantly.

Above, the experimental results for the volume, particle diameter, and aspect ratio of metal halide microparticles (AgClBr microparticles) were considered based on measurements from TEM photographs of the polarizing glass product after the (D) reduction process; for example, the volume of the substantially spherical AgClBr before stretching and the volume of the substantially spheroid shape AgClBr after stretching can be regarded as equal, and also, the AgClBr aspect ratio after stretching and before reduction and the AgClBr aspect ratio after reduction can be regarded as equal.

### <Experiment Regarding Particle Diameter of Metal Microparticles (Ag Microparticles)>

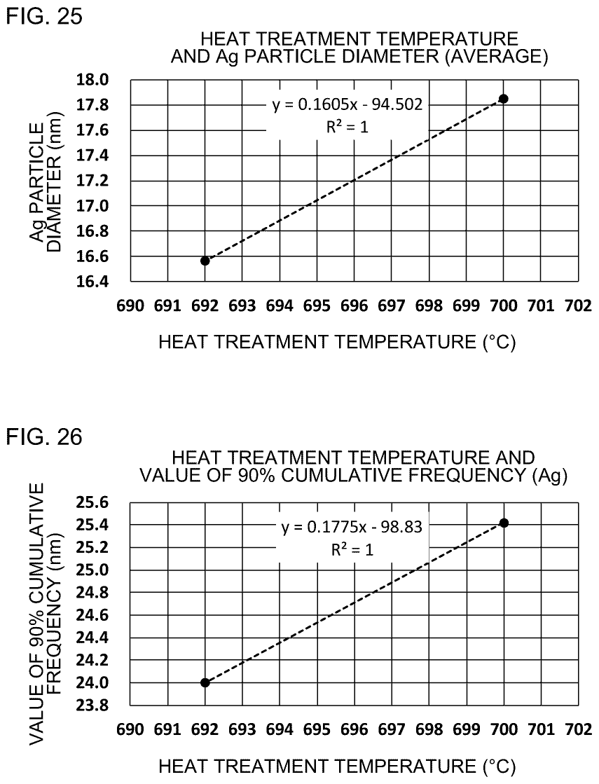

In the experiment, similar to Example 1, Example 2, and Comparative Example 1 above, for each experimental sample, the particle diameter of metal microparticles (Ag microparticles) appearing within a predetermined range was measured using TEM photographs. Individual Ag metal particle diameters were arranged in ascending order, with Ag particle diameter on the horizontal axis and cumulative frequency on the vertical axis, and the cumulative frequency line of Ag metal particle diameter is shown in FIG. 24. Note that the observed number of metal microparticles was about 50 to 100. Furthermore, FIG. 25 is a graph showing the relationship between the heat treatment temperature of the precipitation process and the average value of the particle diameter of Ag microparticles. As shown in FIG. 25, it was found that the heat treatment temperature of the precipitation process and the average value of the particle diameter of Ag microparticles have a substantially linear relationship. Furthermore, FIG. 26 is a graph showing the relationship between the heat treatment temperature and the particle diameter at a cumulative frequency of 90% of metal microparticles. As shown in FIG. 26, it was found that the heat treatment temperature of the precipitation process and the particle diameter (cumulative frequency 90%) of Ag microparticles have a substantially linear relationship.

As shown in FIGS. 24 to 26, the particle diameter of Ag microparticles became larger as the heat treatment temperature in the precipitation process was higher. Namely, the particle diameter of Ag microparticles showed Example 3<Example 4. This is because the particle diameter of the originally precipitated AgClBr microparticles is larger as the heat treatment temperature is higher, and therefore, even after reduction, the particle diameter of Ag microparticles increases in the order of the heat treatment temperature.

As shown in FIGS. 24 and 26, the particle diameter of Ag microparticles in Example 3, at a cumulative frequency of 90%, was about 24 nm, and the particle diameter of Ag microparticles in Example 4 was about 25 nm. Furthermore, when the average value was measured by summing the particle diameters of the samples and dividing by the number of samples, as shown in FIG. 25, the average diameter of Ag microparticles in Example 3 was about 16.6 nm, and the average diameter of Ag microparticles in Example 4 was about 17.9 nm. Hereinafter, the average value and the magnitude at cumulative frequency 90% of the particle diameter of Ag microparticles in Example 3 and Example 4 are summarized in Table 12.

TABLE 12
Unit (nm)

| | |
|---|---|
| Example 3 | Example 4 |
| 692° C. | 700° C. |

| | 90% | | 90% |
|---|---|---|---|
| Average | Cumulative | Average | Cumulative |
| Value | Frequency | Value | Frequency |
| 16.56 | 24.00 | 17.85 | 25.42 |

<Experiment Regarding Number of Ag Microparticles Contained in Cavities Associated with Metal Microparticles (Ag Microparticles)>

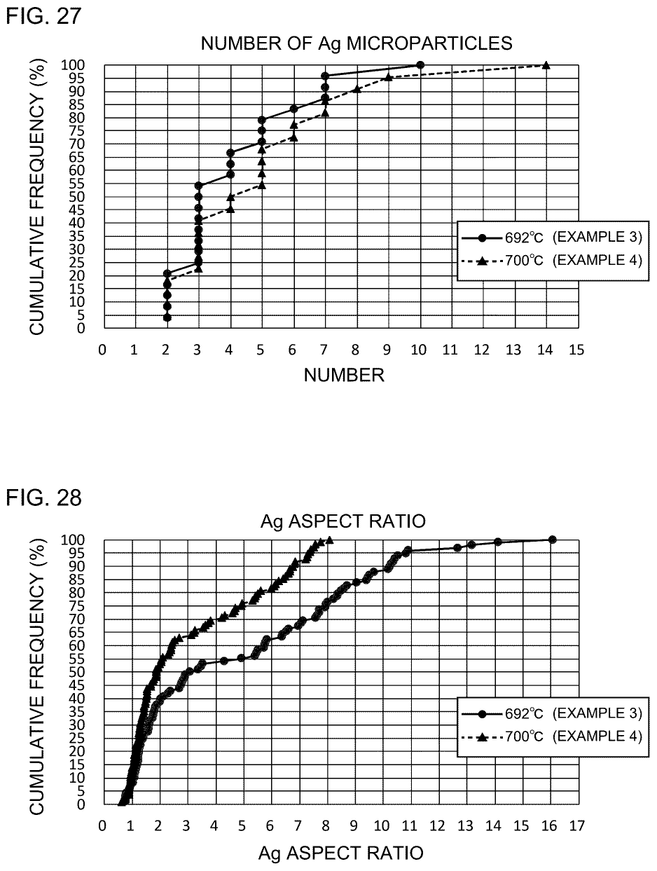

The number of Ag microparticles contained in the cavities was determined from TEM photographs. FIG. 27 shows the relationship between the number of Ag microparticles and cumulative frequency. The average value of the number of Ag microparticles was 4.08 in Example 3 and 4.91 in Example 4. At cumulative frequency 90%, it was 7.00 in Example 3 and 7.80 in Example 4. Hereinafter, the average value and the magnitude at cumulative frequency 90% of the number of Ag microparticles in Example 3 and Example 4 are summarized in Table 13.

TABLE 13
Unit (Counts)

| | |
|---|---|
| Example 3 | Example 4 |
| 692° C. | 700° C. |

| | 90% | | 90% |
|---|---|---|---|
| Average | Cumulative | Average | Cumulative |
| Value | Frequency | Value | Frequency |
| 4.08 | 7.00 | 4.91 | 7.80 |

Between Example 3 and Example 4, Example 3 was stretched with a larger tension than Example 4, but since the particle diameter of AgClBr microparticles was larger in Example 4 than in Example 3, more Ag microparticles were divided within one cavity after reduction, and the number of Ag microparticles became larger in Example 4 than in Example 3.

### <Experiment Regarding Aspect Ratio of Metal Microparticles (Ag Microparticles)>

Similar to Example 1, Example 2, and Comparative Example 1 above, the aspect ratio of the metal microparticles (Ag microparticles) was determined. FIG. 28 shows the relationship between aspect ratio and cumulative frequency.

As shown in FIG. 28, looking at the aspect ratio of Ag microparticles at cumulative frequency 90%, the aspect ratio of Ag microparticles in Example 3 was about 10.2, and the aspect ratio of Ag microparticles in Example 4 was about 6.8. Furthermore, when the average value was measured, the aspect ratio of Ag microparticles in Example 3 was about 4.9, and the aspect ratio of Ag microparticles in Example 4 was about 3.1. Hereinafter, the average value and the magnitude at cumulative frequency 90% of the aspect ratio of Ag microparticles in Example 3 and Example 4 are summarized in Table 14.

TABLE 14

| | |
|---|---|
| Example 3 | Example 4 |
| 692° C. | 700° C. |

| | 90% | | 90% |
|---|---|---|---|
| Average | Cumulative | Average | Cumulative |
| Value | Frequency | Value | Frequency |
| 4.87 | 10.24 | 3.05 | 6.79 |

As shown in Table 14, the aspect ratio of Ag microparticles in Example 4 became smaller than the aspect ratio of Ag microparticles in Example 3. This is considered to be because, as described above, more Ag microparticles were divided within one cavity in Example 4 than in Example 3.

### <Experiment Regarding Volume of Metal Microparticles (Ag Microparticles)>

The volume of the metal microparticles (Ag microparticles) was determined based on the particle diameter of the Ag microparticles obtained in FIG. 24, similar to Example 1, Example 2, and Comparative Example 1 above.

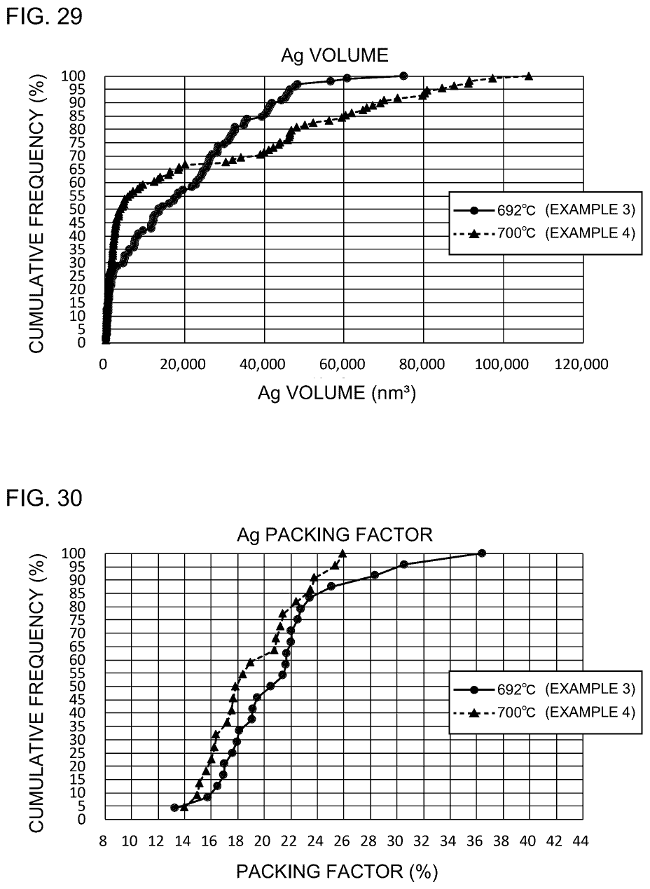

FIG. 29 shows the relationship between the volume of Ag microparticles and cumulative frequency. As shown in FIG. 29, at cumulative frequency 90%, the volume of Ag microparticles in Example 3 was about 42,500 nm³, and the volume of Ag microparticles in Example 4 was about 69,300 nm³. Note that the volume of Ag microparticles is the volume per single Ag microparticle.

Furthermore, the average value of the volume per single Ag microparticle was about 18,800 nm³ in Example 3, and about 22,700 nm³ in Example 4. Hereinafter, the average value and the magnitude at cumulative frequency 90% of the volume of Ag microparticles in Example 3 and Example 4 are summarized in Table 15.

TABLE 15
Unit (nm³)

| | |
|---|---|
| Example 3 | Example 4 |
| 692° C. | 700° C. |

| | 90% | | 90% |
|---|---|---|---|
| Average | Cumulative | Average | Cumulative |
| Value | Frequency | Value | Frequency |
| 18,763 | 42,474 | 22,742 | 69,301 |

As shown in Table 15, the volume of Ag microparticles was larger in Example 4 than in Example 3. This is attributed to the fact that, as mentioned above, the AgClBr particle diameter was larger in Example 4 than in Example 3, and Example 4 was stretched with a smaller tension than Example 3.

### <Experiment Regarding Volume Ratio of Metal Microparticles (Ag Microparticles)>

The volume ratio of Ag microparticles relative to the volume of the cavity was determined. In the experiment, similar to Example 1, Example 2, and Comparative Example 1 above, the ratio of the sum of the volumes of all Ag microparticles existing in one cavity (trace of AgClBr microparticle) to the volume of that cavity ([Sum of volumes of Ag microparticles/Volume of cavity]×100(%)) was determined. This can also be called the packing factor. FIG. 30 shows the experimental results obtained by determining this Ag microparticle volume ratio for all cavities appearing within a predetermined range.

As shown in FIG. 30, the packing factor of the metal microparticles (Ag microparticles), at cumulative frequency 90%, was about 27% for Example 3 and about 24% for Example 4. Furthermore, when the average value was measured, the packing factor of the metal microparticles (Ag microparticles) in Example 3 was about 21.2%, and the packing factor of the metal microparticles (Ag microparticles) in Example 4 was about 19.2%. Hereinafter, the average value and the magnitude at cumulative frequency 90% of the packing factor of Ag microparticles in Example 3 and Example 4 are summarized in Table 16.

TABLE 16
Unit (%)

| | |
|---|---|
| Example 3 | Example 4 |
| 692° C. | 700° C. |

| | 90% | | 90% |
|---|---|---|---|
| Average | Cumulative | Average | Cumulative |
| Value | Frequency | Value | Frequency |
| 21.22 | 27.03 | 19.16 | 23.74 |

Thus, the packing factor was larger in Example 3 than in Example 4.

### <Experiment Regarding Insertion Loss and Extinction Ratio>

Similar to Example 1, Example 2, and Comparative Example 1 above, using the obtained polarizing glasses of Example 3 and Example 4, insertion loss and extinction ratio were determined.

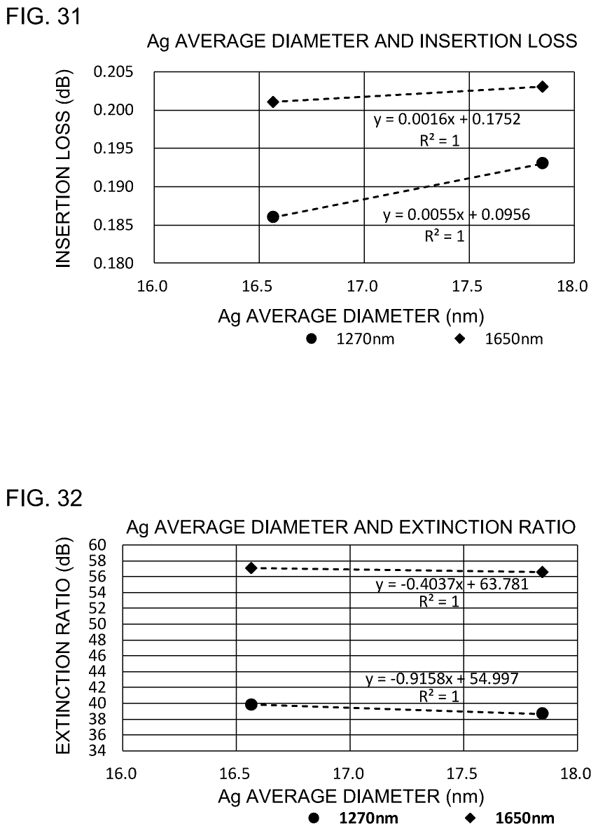

FIG. 31 is a graph showing the relationship between the average diameter of Ag microparticles and insertion loss. As shown in FIG. 31, it was found that the smaller the average diameter of Ag microparticles, the more the insertion loss can be reduced.

Furthermore, FIG. 32 is a graph showing the relationship between the average diameter of Ag microparticles and extinction ratio. As shown in FIG. 32, it was found that the smaller the average diameter of Ag microparticles, the higher the extinction ratio can be made.

From this, it was found that by reducing the average diameter of Ag microparticles, insertion loss can be reduced, and the extinction ratio can be increased.

As shown in FIG. 31, Example 3 and Example 4 could suppress the insertion loss for light of wavelengths 1270 nm and 1650 nm to 0.203 dB or less, and preferably, it was found that it can be suppressed to 0.201 dB or less. Furthermore, from the experimental results shown in FIG. 32, it was found that the extinction ratio can be made 38 dB or more at a measurement distance of 5 mm.

As shown in FIG. 32, in Example 3 and Example 4, the extinction ratio at a measurement distance of 5 mm for light of wavelength 1270 nm was 38 dB or more, and the extinction ratio at a measurement distance of 300 mm for light of wavelength 1650 nm was found to be 50 dB or more.

Based on the above, in the present example, the average diameter of Ag microparticles was set to 20 nm or less, with a preferred range of 10 nm or more and 18 nm or less, and a most preferred range set to 10 nm or more and 17 nm or less.

Although the lower limit value of the average value of Ag microparticles is not limited, for small metal halide microparticles such that the average diameter of Ag microparticles is less than 10 nm, even if the stretching tension is considerably increased, the aspect ratio of the Ag metal becomes small, and a predetermined extinction ratio cannot be obtained. That is, even when stretched with such a large stretching tension that breakage during stretching is unavoidable, if the average diameter of Ag microparticles is less than 10 nm, the aspect ratio of the Ag metal required to obtain the desired extinction ratio cannot be obtained; therefore, the lower limit of the preferred average diameter of Ag microparticles was set to 10 nm.

In the present example, the value at cumulative frequency 90% of the Ag microparticle particle diameter was set to 30 nm or less, with a preferred range of 12 nm or more and 26 nm or less, and a most preferred range set to 12 nm or more and 24 nm or less. The lower limit value of 12 nm in this case was set for the same reason as the lower limit value of the average diameter of the Ag metal mentioned above.

Note that in the polarizing glasses of Example 3 and Example 4, the preferred AgClBr aspect ratio was set to 20 or more as an average value, and 25 or more at cumulative frequency 90% (see Table 11). Furthermore, it was determined preferable that the ratio of the total volume sum of metal microparticles within one cavity (packing factor) is 18% or more as an average value, and the value at cumulative frequency 90% is 20% or more (see Table 16).

### INDUSTRIAL APPLICABILITY

The polarizing element of the present invention can achieve low insertion loss and high extinction ratio, can obtain favorable optical characteristics, and can be applied, for example, to polarizing glass such as pigtail-type optical isolators.

### REFERENCE SIGNS LIST

1: polarizing element (polarizing glass)
2: Glass substrate
3: Cavity
3a: Non-embedded portion
4: Metal microparticle
d1: Particle diameter

1. A polarizing element comprising:
a glass substrate;
a plurality of cavities formed inside the glass substrate extending in one direction; and
metal microparticles arranged within each cavity having a volume smaller than the cavities,
wherein:
an average diameter of the metal microparticles, along a transversal direction orthogonal to a longitudinal direction of the cavities, is 20 nm or less, and
a particle diameter of the metal microparticles, at a cumulative frequency of 90%, is 30 nm or less.

2. The polarizing element according to claim 1, wherein an aspect ratio of the metal microparticles, at a cumulative frequency of 90%, is 6 or more and 16 or less.

3. The polarizing element according to claim 1, wherein the average diameter of the metal microparticles is 18 nm or less, and the particle diameter of the metal microparticles, at a cumulative frequency of 90%, is 26 nm or less.

4. The polarizing element according to claim 1, wherein an average value of a volume of the cavities is 150,000 nm³ or more and 650,000 nm³ or less.

5. The polarizing element according to claim 1, wherein a total volume sum of the metal microparticles, with respect to a volume of the cavities, is, as an average value, 12% or more and 25% or less.

6. The polarizing element according to claim 1, wherein it has an anti-reflection film on one surface of the polarizing element, and
for light in a wavelength band of 1270 nm to 1650 nm, an insertion loss is 0.204 dB or less.

7. The polarizing element according to claim 1, wherein for light in a wavelength band of 1270 nm to 1650 nm, an extinction ratio, at a measurement distance of 5 mm, is 38 dB or more.

8. The polarizing element according to claim 1, wherein, for light of wavelength 1270 nm, an extinction ratio, at a measurement distance of 5 mm, is 38 dB or more, and for light of wavelength 1650 nm, an extinction ratio, at a measurement distance of 300 mm, is 50 dB or more.

9. The polarizing element according to claim 1, wherein the metal microparticles are Cu microparticles or Ag microparticles.

10. The polarizing element according to claim 2, wherein the average diameter of the metal microparticles is 18 nm or less, and the particle diameter of the metal microparticles, at a cumulative frequency of 90%, is 26 nm or less.

11. The polarizing element according to claim 2, wherein an average value of a volume of the cavities is 150,000 nm³ or more and 650,000 nm³ or less.

12. The polarizing element according to claim 2, wherein a total volume sum of the metal microparticles, with respect to a volume of the cavities, is, as an average value, 12% or more and 25% or less.

13. The polarizing element according to claim 2, wherein it has an anti-reflection film on one surface of the polarizing element, and
for light in a wavelength band of 1270 nm to 1650 nm, an insertion loss is 0.204 dB or less.

14. The polarizing element according to claim 2, wherein for light in a wavelength band of 1270 nm to 1650 nm, an extinction ratio, at a measurement distance of 5 mm, is 38 dB or more.

15. The polarizing element according to claim 2, wherein, for light of wavelength 1270 nm, an extinction ratio, at a measurement distance of 5 mm, is 38 dB or more, and for light of wavelength 1650 nm, an extinction ratio, at a measurement distance of 300 mm, is 50 dB or more.

16. The polarizing element according to claim 2, wherein the metal microparticles are Cu microparticles or Ag microparticles.
